(19) United States
(12) Patent Application Publication
(10) Pub. No.: US 2026/0254288 A1
(43) Pub. Date: Aug. 27, 2026

(54) MAGNET, MOTOR INCLUDING SAME, AND WASHING MACHINE INCLUDING SAME

(71) Applicant: LG ELECTRONICS INC., Seoul (KR)

(72) Inventors: Jeonghyun CHO, Seoul (KR); Gyujong JEONG, Seoul (KR); Sangjoon EUM, Seoul (KR); Songe PARK, Seoul (KR); Kyungho HA, Seoul (KR)

(21) Appl. No.: 18/726,558

(22) PCT Filed: Sep. 26, 2023
(86) PCT No.: PCT/KR2023/014879

§ 371 Date: Jul. 3, 2024

(30) Foreign Application Priority Data
Jul. 4, 2023 (KR) 10-2023-0086302

(51) Int. Cl. H02K 1/02; H02K 1/2791; H02K 7/108; H02K 7/116; H02K 21/22

(52) U.S. Cl. CPC H02K 1/02; H02K 1/2791; H02K 7/108; H02K 7/116; H02K 21/22; H02K 2213/03

(57) ABSTRACT

A magnet, a motor including the same, and a washing machine including the same are provided. A magnet according to an aspect of the present disclosure includes a plurality of pole regions formed in an arc shape and arranged in parallel in a circumferential direction, chamfers formed on inner surfaces of both ends of the pole region, and a value obtained by dividing a radial length of the chamfer by a radial length of the pole region is between 0.20 and 0.21.

### TECHNICAL FIELD

The present disclosure relates to a magnet, a motor including the same, and a washing machine including the same. More specifically, the present disclosure relates to a magnet for improving counter electromotive force, a motor including the same, and a washing machine including the same.

### BACKGROUND ART

Generally, a washing machine includes an outer tub containing washing water, and an inner tub rotatably provided in the outer tub to accommodate laundry such as clothes, and washing and dehydration of laundry are performed as the inner tub rotates.

A washing machine may be classified into a top loading type washing machine in which a rotation center of the inner tub is formed in a direction perpendicular to a bottom and is designed to allow laundry to be loaded from the upper side, and a front loading type washing machine in which the rotation center of the inner tub is formed in a direction horizontal to the bottom or inclined in a direction that decreases toward the rear end and is designed to allow laundry to be loaded from the front.

The top loading type washing machine can be largely divided into an agitator type washing machine and a pulsator type washing machine. The agitator type washing machine performs washing by rotating a washing rod raised in the center of the inner drum, and the pulsator type washing machine performs washing by rotating a disc-shaped pulsator formed at the bottom of the inner drum.

The front loading type washing machine is commonly called a “drum washing machine”, and includes a lifter installed on the inner surface of the inner drum. In the front loading type washing machine, as the drum rotates, the lifter lifts and drops the laundry to perform washing.

The washing machine is operated in two main operating modes (washing mode, dehydration mode) with different operating conditions.

In order to satisfy both of the two main operating modes, the washing machine is equipped with a clutch and operates an output shaft at low speed and high torque with a gear ratio of n:1 (washing mode) or operates the output shaft at high speed and low torque with a gear ratio of 1:1 (dehydration mode).

In this case, there is a structure that reduces power consumption and improves the operating efficiency of the motor by adding a planetary gear.

In general, the washing machine is equipped with an outer rotor motor. In the outer rotor motor, a stator around coils are wound is installed on the inside, and the rotor is arranged radially outside the stator as if magnets surround the coils of the stator. The rotor includes a plurality of magnets arranged radially.

Before becoming a magnet, a general magnetic material has electrons arranged randomly. In order to magnetize such a magnetic material, first, by orienting the electron arrangement in the magnetic material in a certain direction, and then by going through a magnetization process in which an external magnetic field is applied to magnetically polarize the magnetic material, and thus, a permanent magnet can be formed.

A method of concentrating a magnetic flux distribution is used to increase the size of the counter electromotive force based on the same magnet usage, but there is a problem that cracks occurred in the magnet due to the concentration of the magnetic flux distribution.

In addition, in the case of a magnet having a plurality of pole regions, there is a problem that the performance is lowered compared to a magnet with a single pole due to a magnetic division region connecting the plurality of pole regions and the magnetic division region at both ends of the magnet.

### DISCLOSURE

### Technical Problem

An object of the present disclosure is to provide a magnet that can increase a counter electromotive force of a motor while reducing the possibility of cracks occurring in the magnet, a motor including the same, and a washing machine including the same.

In addition, an object of the present disclosure is to provide a magnet that can reduce a cogging torque of a motor and improve the counter electromotive force of the motor, a motor including the same, and a washing machine including the same.

### Technical Solution

A magnet according to an aspect of the present disclosure may include a plurality of pole regions formed in an arc shape and arranged in parallel in a circumferential direction.

In this case, chamfers formed on inner surfaces of both ends of the pole region.

Therefore, a cogging torque of the motor can be reduced and a counter electromotive force of the motor can be improved.

Moreover, a value obtained by dividing a radial length of the chamfer by a radial length of the pole region may be between 0.20 and 0.21. Preferably, the value obtained by dividing the radial length of the chamfer by the radial length of the pole region may be between 0.208 and 0.209.

Moreover, a value obtained by dividing a circumferential length of the chamber by a circumferential length of the pole region may be between 0.19 and 0.20. Preferably, the value obtained by dividing the circumferential length of the chamber by the circumferential length of the pole region may be between 0.193 and 0.194.

A cross section of the chamber may be formed as a straight line or a curve.

A magnet according to an aspect of the present disclosure may include a plurality of pole regions formed in an arc shape and arranged in parallel in a circumferential direction, and each of the plurality of pole regions may have a magnetic focus center different from a center of an inner diameter of the plurality of pole regions.

In this case, chamfers formed on inner surfaces of both ends of the pole region.

Therefore, a cogging torque of the motor can be reduced and a counter electromotive force of the motor can be improved.

A value obtained by dividing a radial length of the chamfer by a radial length of the pole region is between 0.16 and 0.17. Preferably, the value obtained by dividing the radial length of the chamfer by the radial length of the pole region may be between 0.166 and 0.167.

Moreover, a value obtained by dividing a circumferential length of the chamfer by a circumferential length of the pole region may be between 0.155 and 0.165. Preferably, the value obtained by dividing the circumferential length of the chamfer by the circumferential length of the pole region may be between 0.1595 and 0.1605.

A cross section of the chamber may be formed as a straight line or a curve.

The plurality of pole regions may satisfy the following Expression

$$X = \frac{{d}_{m}}{{d}_{b}} .$$

Here, dm is a distance from a straight line connecting both ends of a magnetic center line of the plurality of pole regions to a central region of the magnetic center line of the plurality of pole regions, and db is a distance from a straight line connecting both ends of the magnetic center line of the plurality of pole regions to the central region of the magnetic center line of the plurality of pole regions when the plurality of pole regions have the same magnetic focus center as the center of the inner diameter of the plurality of pole regions.

X<6 when the plurality of pole regions is 2, X<4.5 when the plurality of pole regions is 3, and X<3.5 when the plurality of pole regions is 4.

Accordingly, it is possible to reduce the possibility of cracks in the magnet while increasing the counter electromotive force of the motor.

A motor according to an aspect of the present disclosure may include a stator and a rotor including a rotor core arranged radially outside the stator and a plurality of magnets arranged on an inner surface of the rotor core and facing the stator.

A washing machine according to an aspect of the present disclosure may include the motor.

### Advantageous Effects

According to the present disclosure, it is possible to provide a magnet capable of increasing the counter electromotive force of a motor while reducing the possibility of cracks occurring in the magnet, a motor including the same, and a washing machine including the same.

In addition, according to the present disclosure, it is possible to provide a magnet capable of reducing the cogging torque of a motor and improving the counter electromotive force of the motor, a motor including the same, and a washing machine including the same.

### DESCRIPTION OF DRAWINGS

FIGS. 1 and 2 are perspective views of a washing machine according to one embodiment of the present disclosure.

FIG. 3 is a perspective view of the washing machine drive system according to one embodiment of the present disclosure.

FIG. 4 is an exploded perspective view of the washing machine drive system according to one embodiment of the present disclosure.

FIG. 5 is an exploded perspective view of a washing machine drive system according to another embodiment of the present disclosure.

FIG. 6 is a plan view of a rotor according to one embodiment of the present disclosure.

FIGS. 7 to 10 are plan views of a magnet according to one embodiment of the present disclosure.

FIG. 11 is a plan view of a rotor according to one embodiment of the present disclosure.

FIG. 12 is an enlarged view of part A of FIG. 11.

FIG. 13 is a plan view of a pole region according to one embodiment of the present disclosure.

FIG. 14 is a graph illustrating an increase rate of a counter electromotive force of a motor with respect to a polar anisotropy coefficient of a magnet according to one embodiment of the present disclosure.

FIG. 15 is a graph illustrating a change rate of a material cost of a stator with respect to a polar anisotropy coefficient of a magnet according to one embodiment of the present disclosure.

FIG. 16 is a graph illustrating a ratio of a rotor manufacturing cost with respect to the number of pole regions in one magnet according to one embodiment of the present disclosure.

FIG. 17 is a graph illustrating a change rate of a material cost of a motor with respect to the polar anisotropy coefficient of a magnet according to one embodiment of the present disclosure.

FIG. 18 is a graph illustrating the increase rate of the counter electromotive force of a motor with respect to a polar anisotropy coefficient of a magnet according to one embodiment of the present disclosure.

FIGS. 19 to 21 are plan views of a magnet according to one embodiment of the present disclosure.

FIG. 22 is a graph illustrating an average of change rates of the counter electromotive forces of the motor according to a percentage obtained by dividing a radial length of an outer chamfer of a pole region of the magnet by a radial length of the pole region according to one embodiment of the present disclosure.

FIG. 23 is a graph illustrating an average of change rates of cogging torques of the motor according to a percentage obtained by dividing the radial length of the outer chamfer of the pole region of the magnet by the radial length of the pole region according to one embodiment of the present disclosure.

FIG. 24 is a graph illustrating an average of weights of the motor according to a percentage obtained by dividing the radial length of the outer chamfer of the pole region of the magnet by the radial length of the pole region according to one embodiment of the present disclosure.

FIG. 25 is a graph illustrating an average of change rates of counter electromotive forces of the motor according to a percentage obtained by dividing a circumferential length of the outer chamfer of the pole region of the magnet by a circumferential length of the pole region according to one embodiment of the present disclosure.

FIG. 26 is a graph illustrating an average of change rates of cogging torques of a motor according to a percentage obtained by dividing the circumferential length of the outer chamfer of the pole region of the magnet by the circumferential length of the pole region according to one embodiment of the present disclosure.

FIG. 27 is a graph illustrating an average of weights of a motor according to a percentage obtained by dividing the circumferential length of the outer chamfer of the pole region of the magnet by the circumferential length of the pole region according to one embodiment of the present disclosure.

FIG. 28 is a graph illustrating an average of change rates of counter electromotive forces of the motor according to a percentage obtained by dividing a radial length of an inner chamfer of the pole region of the magnet by a radial length of the pole region according to one embodiment of the present disclosure.

FIG. 29 is a graph illustrating an average of change rates of cogging torques of the motor according to a percentage obtained by dividing the radial length of the inner chamfer of the pole region of the magnet by the radial length of the pole region according to one embodiment of the present disclosure.

FIG. 30 is a graph illustrating an average of weights of the motor according to a percentage obtained by dividing the radial length of the inner chamfer of the pole region of the magnet by the radial length of the pole region according to one embodiment of the present disclosure.

FIG. 31 is a graph illustrating an average of change rates of counter electromotive forces of the motor according to a percentage obtained by dividing the circumferential length of the inner chamfer of the pole region of the magnet by the circumferential length of the pole region according to one embodiment of the present disclosure.

FIG. 32 is a graph illustrating an average of change rates of cogging torques of the motor according to a percentage by dividing the circumferential length of the inner chamfer of the pole region of the magnet by the circumferential length of the pole region according to one embodiment of the present disclosure.

FIG. 33 is a graph illustrating an average of weights of the motor according to a percentage obtained by dividing the circumferential length of the inner chamfer of the pole region of the magnet by the circumferential length of the pole region according to one embodiment of the present disclosure.

FIG. 34 is a graph illustrating an average of change rates of counter electromotive forces of a motor according to a percentage obtained by dividing the radial length of the outer chamfer of the pole region of the magnet by the radial length of the pole region according to one embodiment of the present disclosure.

FIG. 35 is a graph illustrating an average of change rates of cogging torques of the motor according to a percentage obtained by dividing the radial length of the outer chamfer of the pole region of the magnet by the radial length of the pole region according to one embodiment of the present disclosure.

FIG. 36 is a graph illustrating an average of weights of the motor according to the percentage obtained by dividing the radial length of the outer chamfer of the pole region of the magnet by the radial length of the pole region according to one embodiment of the present disclosure.

FIG. 37 is a graph illustrating an average of change rates of counter electromotive forces of the motor according to the percentage obtained by dividing the circumferential length of the outer chamfer of the pole region of the magnet by the circumferential length of the pole region according to one embodiment of the present disclosure.

FIG. 38 is a graph illustrating an average of change rates of cogging torques of the motor according to the percentage obtained by dividing the circumferential length of the outer chamfer of the pole region of the magnet by the circumferential length of the pole region according to one embodiment of the present disclosure.

FIG. 39 is a graph illustrating an average of weights of the motor according to the percentage obtained by dividing the circumferential length of the outer chamfer of the pole region of the magnet by the circumferential length of the pole region according to one embodiment of the present disclosure.

FIG. 40 is a graph illustrating an average of change rates of counter electromotive forces of the motor according to the percentage obtained by dividing the radial length of the inner chamfer of the pole region of the magnet by the radial length of the pole region according to one embodiment of the present disclosure.

FIG. 41 is a graph illustrating an average of change rates of cogging torques of the motor according to the percentage obtained by dividing the radial length of the inner chamfer of the pole region of the magnet by the radial length of the pole region according to one embodiment of the present disclosure.

FIG. 42 is a graph illustrating an average of weights of the motor according to a percentage obtained by dividing the radial length of the inner chamfer of the pole region of the magnet by the radial length of the pole region according to one embodiment of the present disclosure.

FIG. 43 is a graph illustrating an average of change rates of counter electromotive forces of the motor according to the percentage obtained by dividing the circumferential length of the inner chamfer of the pole region of the magnet by the circumferential length of the pole region according to one embodiment of the present disclosure.

FIG. 44 is a graph illustrating an average of change rates of cogging torques of the motor according to the percentage obtained by dividing the circumferential length of the inner chamfer of the pole region of the magnet by the circumferential length of the pole region according to one embodiment of the present disclosure.

FIG. 45 is a graph illustrating an average of weights of the motor according to the percentage obtained by dividing the circumferential length of the inner chamfer of the pole region of the magnet by the circumferential length of the pole region according to one embodiment of the present disclosure.

FIG. 46 is a graph illustrating counter electromotive forces of motors according to the prior art and one embodiment of the present disclosure.

FIG. 47 is a graph illustrating cogging torques of the motors according to the prior art and one embodiment of the present disclosure.

### MODE FOR DISCLOSURE

Hereinafter, embodiments disclosed in this disclosure will be described in detail with reference to the attached drawings, and regardless of the drawing symbols, identical or similar components will be given the same reference numerals and redundant descriptions thereof will be omitted.

When describing the embodiments disclosed in this disclosure, when it is mentioned that a component is “coupled” or “connected” to another component, it should be understood that it may be directly connected or connected to the other component, but other components may exist therebetween.

In addition, when describing the embodiments disclosed in this disclosure, in a case where it is determined that a specific description of a related known technology may obscure the gist of the embodiments disclosed in this disclosure, the detailed description thereof will be omitted. In addition, the attached drawings are only intended to facilitate easy understanding of the embodiments disclosed in the present disclosure, and the technical ideas disclosed in the present disclosure are not limited by the attached drawings, and should be understood to include all modifications, equivalents, or substitutes included in the scope of the ideas and technologies of the present disclosure.

Meanwhile, the term such as the disclosure may be replaced with terms such as document, specification, and description.

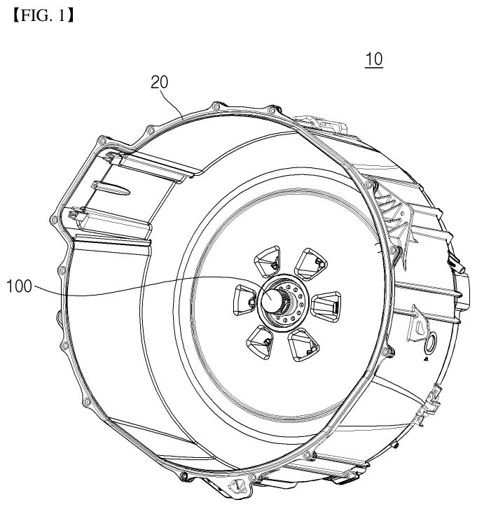

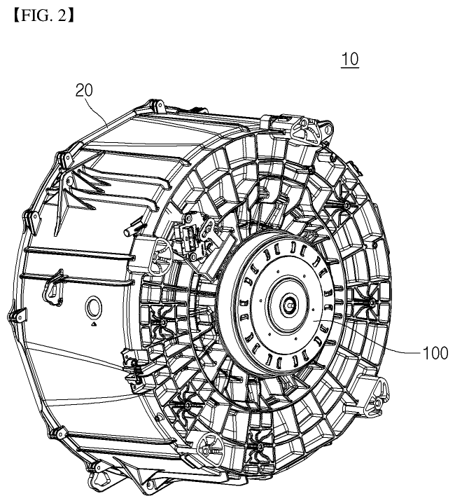

FIGS. 1 and 2 are perspective views of a washing machine according to one embodiment of the present disclosure.

Referring to FIGS. 1 and 2, a washing machine 10 according to one embodiment of the present disclosure may include an outer tub 20 and a washing machine drive system 100, but may be implemented excluding some of the configurations thereof, and does not exclude additional configurations.

The washing machine 10 according to one embodiment of the present disclosure is described as an example of a front loading type washing machine in which a rotation center of an inner tub is formed to be inclined in a direction horizontal to the bottom or in a direction lowering toward the rear end, and laundry can be loaded from the front. However, the detailed configuration of the washing machine drive system 100 can also be applied to a top loading type washing machine.

The outer drum 20 may be a cylindrical shape with an open top or front. An inner drum (not illustrated) may be arranged inside the outer drum 20. The outer drum 20 may be formed of a plastic material. The inner drum may be connected to an output shaft 110 of the washing machine drive system 100. The washing machine drive system 100 may be coupled to the inner tub of the washing machine 10 to rotate the inner drum.

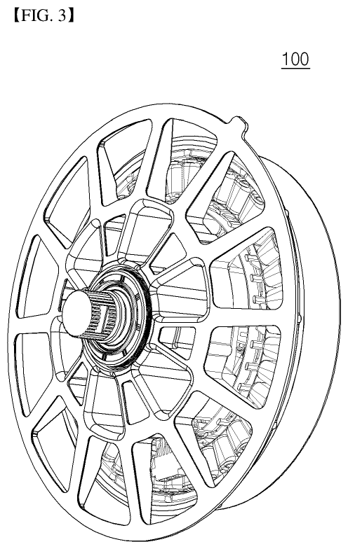

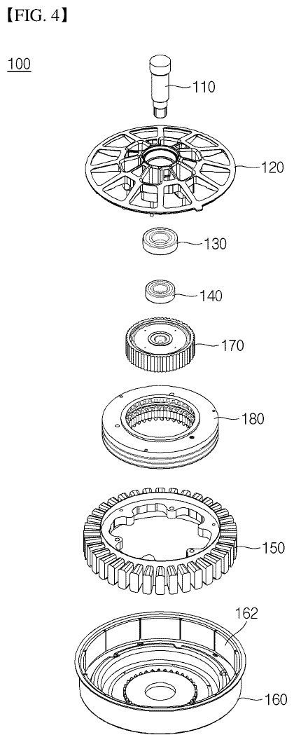

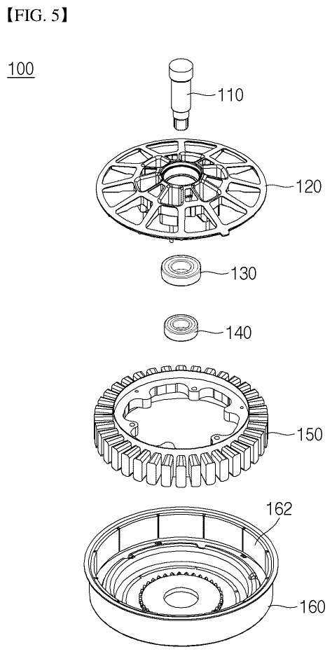

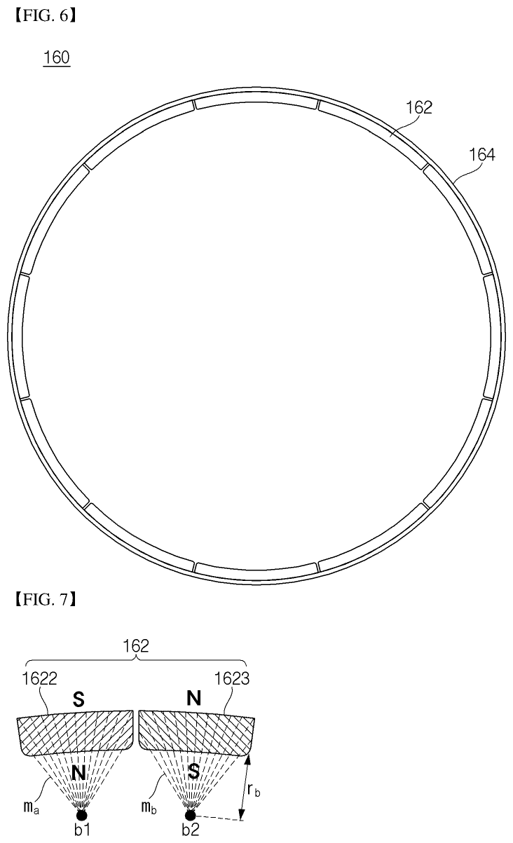

FIG. 3 is a perspective view of the washing machine drive system according to one embodiment of the present disclosure. FIG. 4 is an exploded perspective view of the washing machine drive system according to one embodiment of the present disclosure. FIG. 5 is an exploded perspective view of the washing machine drive system according to another embodiment of the present disclosure. FIG. 6 is a plan view of a rotor according to one embodiment of the present disclosure.

Referring to FIGS. 3, 4, and 6, the washing machine drive system 100 according to one embodiment of the present disclosure may include the output shaft 110, a housing 120, a first bearing 130, a second bearing 140, a stator 150, a rotor 160, a planetary gear set 170, and a clutch 180, but may be implemented without some of these configurations, and additional configurations are not excluded.

As illustrated in FIG. 5, the washing machine drive system 100 may be implemented without the planetary gear set 170 and the clutch 180.

The output shaft 110 may extend in the axial direction. The output shaft 110 may be coupled to the inner tub. The output shaft 110 may be rotatably coupled to the housing 120. The output shaft 110 may be bearing-coupled to the housing 120. The output shaft 110 may be coupled to a planetary gear set 170.

The inner tub may be coupled to the upper region of the output shaft 110. The center region of the output shaft 110 may be bearing-coupled to the housing 120. The first bearing 130 and the second bearing 140 may be arranged between the center region of the output shaft 110 and the housing 120.

A lower region of the output shaft 110 may be arranged inside the rotor 160. The lower region of the output shaft 110 may be coupled to the planetary gear set 170. A diameter of the lower region of the output shaft 110 may be formed smaller than a diameter of the center region. An axial length of the lower region of the output shaft 110 may be formed shorter than an axial length of the center region of the output shaft 110.

The output shaft 110 may be rotatably coupled to the housing 120. The inner tub and the outer tub 20 may be arranged in the upper part of the housing 120. The housing 120 may be coupled to the outer tub 20. The stator 150, the rotor 160, the planetary gear set 170, and the clutch 180 may be arranged in the lower part of the housing 120. The housing 120 may be coupled to the stator 150. The housing 120 may be formed of a plastic material.

The first bearing 130 may be arranged between the output shaft 110 and the housing 120. The first bearing 130 may bearing-couple the output shaft 110 to the housing 120. The first bearing 130 may rotatably couple the output shaft 110 to the housing 120. The first bearing 130 may be extended in a circumferential direction. The first bearing 130 may be arranged above the second bearing 140.

The second bearing 140 may be arranged between the output shaft 110 and the housing 120. The second bearing 140 may bear-couple the output shaft 110 to the housing 120. The second bearing 140 may rotatably couple the output shaft 110 to the housing 120. The second bearing 140 may extend in the circumferential direction. The second bearing 140 may be arranged below the first bearing 130. The second bearing 140 may be arranged above the planetary gear set 170. The second bearing 140 may be arranged radially inwardly of the stator 150.

The stator 150 may be coupled to the housing 120. The stator 150 may be arranged inside the rotor 160. The stator 150 may face the rotor 160. The stator 150 may be arranged above the clutch 180. The stator 150 may include a coupling portion coupled to the housing 120, a stator arranged radially outside the coupling portion, and a coil wound around the stator. The stator 150 may rotate the rotor 160 through electromagnetic interaction.

The rotor 160 may face the stator 150. The rotor 160 may be coupled with the planetary gear set 170. Accordingly, the rotor 160 may supply rotational power to the output shaft 110.

The rotor 160 may include a rotor core 164 disposed radially outside the stator 150 and a magnet 162 disposed on an inner surface of the rotor core 164. The magnet 162 may face the stator 150. The magnet 162 may face the stator of the stator 150. When current is supplied to the coil of the stator 150, the magnet 162 may rotate in one direction or the other direction by the electromagnetic interaction.

The magnet 162 may include a plurality of magnets spaced apart in the circumferential direction. The plurality of magnets may be radially arranged based on the center region of the rotor core 164. The plurality of magnets may face a plurality of stators spaced apart in the circumferential direction, respectively.

The stator 150 and the rotor 160 may be referred to as a “motor”.

The planetary gear set 170 may be spline-coupled to the outer peripheral surface of the output shaft 110. The planetary gear set 170 may be coupled to the rotor 160. The planetary gear set 170 may rotate integrally with the rotor 160. The planetary gear set 170 may transmit the rotational power of the rotor 160 to the output shaft 110.

For example, the planetary gear set 170 may reduce the rotational power of the rotor 160 at a gear ratio of n:1 and transmit the reduced rotational power to the output shaft 110, or transmit the rotational power of the rotor 160 to the output shaft 110 at a gear ratio of 1:1. Accordingly, a washing mode and a dehydration mode can be implemented without a stop operation between the end of the washing and the start of the dehydration.

The clutch 180 can be arranged between the motor 150 and 160 and the planetary gear set 170. A part of the clutch 180 may be spline-coupled to the planetary gear set 170, and the other part thereof may be coupled to the stator 150. The clutch 180 may fix or release a part of the planetary gear set 170. Accordingly, the clutch 180 may allow the planetary gear set 170 to transmit the rotational power of the rotor 160 to the output shaft 110 at a gear ratio of 1:1, or to transmit the rotational power to the output shaft 110 at a gear ratio of n:1.

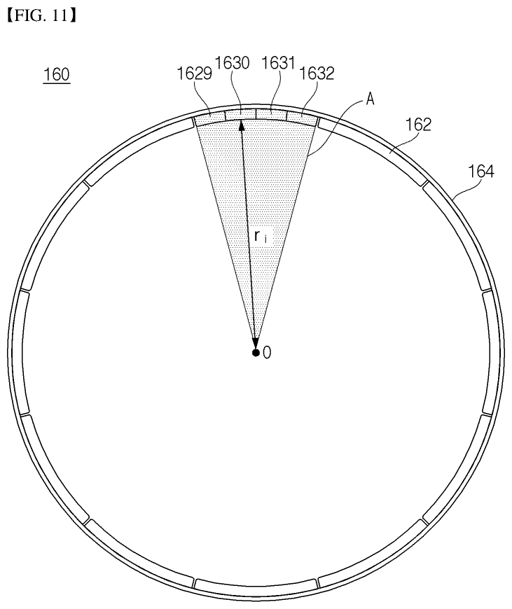

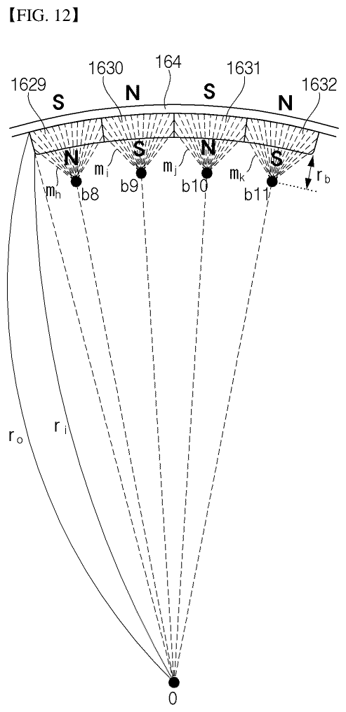

FIGS. 7 to 10 are plan views of a magnet according to one embodiment of the present disclosure. FIG. 11 is a plan view of the rotor according to one embodiment of the present disclosure. FIG. 12 is an enlarged view of part A of FIG. 11.

The magnet 162 according to one embodiment of the present disclosure may also be applied to the washing machine 10 driven without the planetary gear set 170 and the clutch 180, as illustrated in FIG. 5.

Referring to FIG. 7, the magnet 162 may include single pole regions 1622 and 1623. The single pole regions 1622 and 1623 may be spaced apart in a circumferential direction. The single pole regions 1622 and 1623 may be arranged parallel in parallel in a circumferential direction. The single pole regions 1622 and 1623 arranged adjacent to each other may have different polarities. For example, the inner surface of the first pole region 1622 may have an N pole, the inner surface of the second pole region 1623 spaced apart from the first pole region 1622 in the circumferential direction may have an S pole.

The single pole region 1622 and 1623 may be formed as an arc shape overall. The adjacent single pole regions 1622 and 1623 may have their respective magnetic focus centers b1 and b2 that are different from a center O of an inner diameter ri of the single pole regions 1622 and 1623. For example, a first magnetic focus center b1 may be a focus center of a first magnetic orientation ma of the first pole region 1622, and a second magnetic focus center b2 may be a focus center of the second magnetic orientation mb of the second pole region 1623. Distances rb between the magnetic focus centers b1 and b2 of the adjacent single pole regions 1622 and 1623 and the single pole regions 1622 and 1623 may be equal to each other.

In one embodiment of the present disclosure, a case where the magnet 162 is formed by a single pole region 1622 and 1623 may be defined as a “one-pole magnet”.

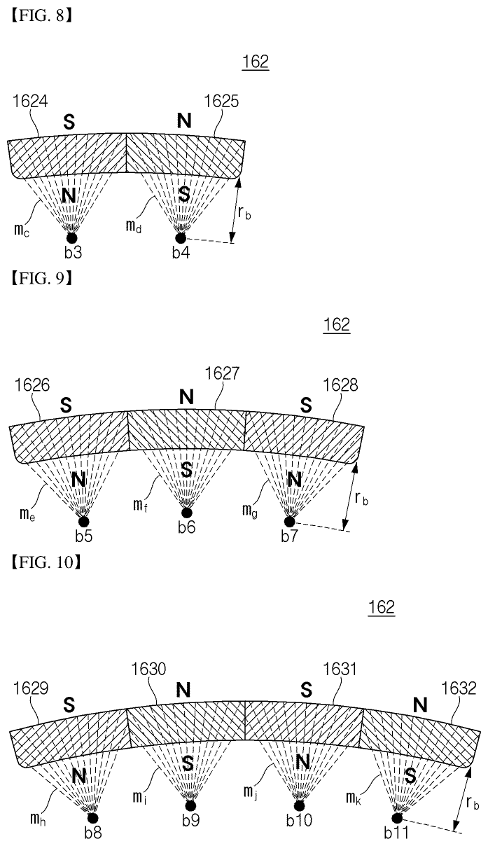

Referring to FIG. 8, the magnet 162 may include two pole regions 1624 and 1625. The two pole regions 1624 and 1625 may be arranged in a circumferential direction. The two pole regions 1624 and 1625 may have different polarities. For example, the inner surface of the third pole region 1624 may have an N pole, and the inner surface of the fourth pole region 1625 may have an S pole.

The two pole regions 1624 and 1625 may be formed as an arc shape overall. The two adjacent pole regions 1624 and 1625 may have their respective magnetic focus centers b3 and b4 that are different from the centers O of the inner diameters ri of the two pole regions 1624 and 1625. For example, the third magnetic focus center b3 may be a focus center of a third magnetic orientation mc of the third pole region 1624, and the fourth magnetic focus center b4 may be a focus center of a fourth magnetic orientation md of the fourth pole region 1625. The magnetic focus centers b3 and b4 of the two pole regions 1624 and 1625 and the distances rb between the two pole regions 1624 and 1625 may be equal to each other. Circumferential distances between the magnetic focus centers b3 and b4 of the two pole regions 1624 and 1625 and the adjacent magnetic focus centers may be equal to each other.

In one embodiment of the present disclosure, a case where the magnet 162 is formed by two pole regions 1624 and 1625 may be defined as a “two-pole magnet”.

Referring to FIG. 9, the magnet 162 may include three pole regions 1626, 1627, and 1628. The three pole regions 1626, 1627, and 1628 may be arranged in a parallel manner in the circumferential direction. The three pole regions 1626, 1627, and 1628 may have different polarities. For example, an inner surface of a fifth pole region 1626 may have a N pole, an inner surface of a sixth pole region 1627 may have a S pole, and an inner surface of a seventh pole region 1628 may have a N pole.

The three pole regions 1626, 1627, and 1628 may be formed as an arc shape overall. The three adjacent pole regions 1626, 1627, and 1628 may have their respective magnetic focus centers b5, b6, and b7 that are different from the center O of the inner diameter ri of the three pole regions 1626, 1627, and 1628. For example, the fifth magnetic focus center b5 may be a focus center of a fifth magnetic orientation me of the fifth pole region 1626, the sixth magnetic focus center b6 may be a focus center of a sixth magnetic orientation mf of the sixth pole region 1627, and the seventh magnetic focus center b7 may be the focus center of the seventh magnetic orientation mg of the seventh pole region 1628. Distances rb between the magnetic focus centers b5, b6, and b7 of the three pole regions 1626, 1627, and 1628 and the three pole regions 1626, 1627, and 1628 may be equal to each other. Circumferential distances between the magnetic focus centers b5, b6, and b7 of the three pole regions 1626, 1627, and 1628 and the adjacent magnetic focus centers may be equal to each other.

In one embodiment of the present disclosure, a case where a magnet 162 is formed by three pole regions 1626, 1627, and 1628 may be defined as a “three-pole magnet”.

Referring to FIGS. 10 to 12, the magnet 162 may include four pole regions 1629, 1630, 1631, and 1632. The four pole regions 1629, 1630, 1631, and 1632 may be arranged in parallel in a circumferential direction. The four pole regions 1629, 1630, 1631, and 1632 may have different polarities. For example, an inner surface of an eighth pole region 1629 may have a N pole, an inner surface of a ninth pole region 1630 may have a S pole, an inner surface of a tenth pole region 1631 may have a N pole, and an inner surface of an eleventh pole region 1632 may have a S pole. The four pole regions 1629, 1630, 1631, and 1632 may be formed as an arc shape overall.

The four adjacent pole regions 1629, 1630, 1631, and 1632 may have their respective magnetic focus centers b8, b9, b10, and b11 that are different from the center O of the inner diameter ri of the four pole regions 1629, 1630, 1631, and 1632. For example, the eighth magnetic focus center b8 may be a focus center of an eighth magnetic orientation mh of the eighth pole region 1629, the ninth magnetic focus center b9 may be a focus center of a ninth magnetic orientation mi of the ninth pole region 1630, the tenth magnetic focus center b10 may be a focus center of a tenth magnetic orientation mj of the tenth pole region 1631, and the eleventh magnetic focus center b11 may be a focus center of an eleventh magnetic orientation mk of the eleventh pole region 1632.

In this case, distances rb between the magnetic focus centers b8, b9, b10, and b11 of the four pole regions 1629, 1630, 1631, and 1632 and the four pole regions 1629, 1630, 1631, and 1632 may be equal to each other. Circumferential distances between the magnetic focus centers b8, b9, b10, and b11 of the four pole regions 1629, 1630, 1631, and 1632 and the adjacent magnetic focus centers may be equal to each other.

In one embodiment of the present disclosure, a case where the magnet 162 is formed by four pole regions 1629, 1630, 1631, and 1632 may be defined as a “four-pole magnet”.

In one embodiment of the present disclosure, the number of multiple magnets spaced apart in the circumferential direction may be 48 when the number of at least one pole regions 1622 and 1623 is one, the number of multiple magnets spaced apart in the circumferential direction may be 24 when the number of at least one pole regions 1624 and 1625 is two, the number of multiple magnets spaced apart in the circumferential direction may be 24 when the number of at least one pole regions 1626, 1627, and 1628 is three, and the number of multiple magnets spaced apart in the circumferential direction may be 12 when the number of at least one pole regions 1629, 1630, 1631, and 1632 is four. Accordingly, the space efficiency of the motor 150 and 160 applied to the washing machine 10 can be improved.

In one embodiment of the present disclosure, the number of at least one pole regions 1622, 1623, 1624, 1625, 1626, 1627, 1628, 1629, 1630, 1631, and 1632 is described as having one to four as an example, but the case of having five or more is not excluded.

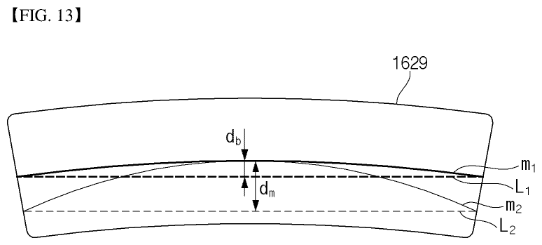

FIG. 13 is a plan view of a pole region according to one embodiment of the present disclosure.

A polar anisotropy coefficient X is described with reference to FIG. 13.

dm means a distance from a straight line L2 connecting both ends of the magnetic center line m2 of at least one pole region 1622, 1623, 1624, 1625, 1626, 1627, 1628, 1629, 1630, 1631, or 1632 to the center region of the magnetic center line m2 of at least one pole region 1622, 1623, 1624, 1625, 1626, 1627, 1628, 1629, 1630, 1631, or 1632.

db means a distance from the straight line L1 connecting both ends of the magnetic center line m1 of at least one pole region 1622, 1623, 1624, 1625, 1626, 1627, 1628, 1629, 1630, 1631, or 1632 to the center region of the magnetic center line m1 of at least one pole region 1622, 1623, 1624, 1625, 1626, 1627, 1628, 1629, 1630, 1631, or 1632 when at least one pole region 1622, 1623, 1624, 1625, 1626, 1627, 1628, 1629, 1630, 1631, or 1632 has the magnetic focus center equal to the center O of the inner diameter ri of at least one pole region 1622, 1623, 1624, 1625, 1626, 1627, 1628, 1629, 1630, 1631, or 1632.

In FIG. 13, dm and db are explained based on a vertical line spaced left and right, but this is only a drawing to help understanding, and in reality, dm and db may be interpreted as meaning the length based on the vertical line overlapping each other.

Here, db may satisfy Expression 1.

$${d}_{b} = \frac{{r}_{i} + {r}_{0}}{2} - √ {( \frac{{r}_{i} + {r}_{0}}{2} )}^{2} - {( \frac{{r}_{0} - {r}_{i}}{2 p} )}^{2} \qquad [ Expression 1 ]$$

Here, ri may represent an inner radius of at least one pole region 1622, 1623, 1624, 1625, 1626, 1627, 1628, 1629, 1630, 1631, or 1632, ro may represent an outer radius of at least one pole region 1622, 1623, 1624, 1625, 1626, 1627, 1628, 1629, 1630, 1631, or 1632, and p may represent the number of poles of at least one pole region 1622, 1623, 1624, 1625, 1626, 1627, 1628, 1629, 1630, 1631, or 1632.

The polar anisotropy coefficient X is a coefficient that determines how close the magnetic focus center of at least one pole region 1622, 1623, 1624, 1625, 1626, 1627, 1628, 1629, 1630, 1631, or 1632 is arranged to at least one pole region 1622, 1623, 1624, 1625, 1626, 1627, 1628, 1629, 1630, 1631, or 1632, and may satisfy the following Expression 2.

$$X = \frac{{d}_{m}}{{d}_{b}} \qquad [ Expression 2 ]$$

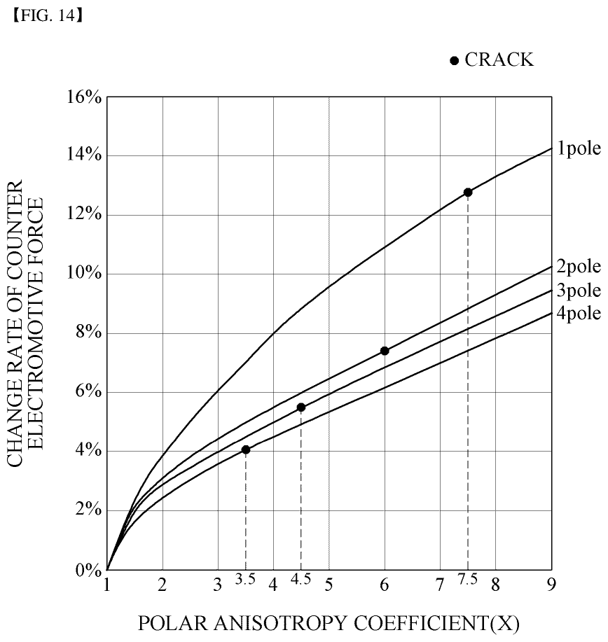

FIG. 14 is a graph illustrating an increase rate of a counter electromotive force of the motor with respect to the polar anisotropy coefficient of the magnet according to one embodiment of the present disclosure.

Referring to FIG. 14, the increase rate of the counter electromotive force with respect to the polar anisotropy coefficient X of the magnet 162 can be known. As the polar anisotropy coefficient X of the magnet 162 increases, the increase rate of the counter electromotive force of the motor 150 and 160 increases. Here, the increase rate of the counter electromotive force means the ratio of the counter electromotive force when the polar anisotropy coefficient X changes with respect to the counter electromotive force when the polar anisotropy coefficient X is 1. The closer the magnetic focus center b1, b2, b3, b4, b5, b6, b7, b8, b9, b10, or b11 of at least one pole region 1622, 1623, 1624, 1625, 1626, 1627, 1628, 1629, 1630, 1631, or 1632 gets to at least one pole region 1622, 1623, 1624, 1625, 1626, 1627, 1628, 1629, 1630, 1631, or 1632, the higher the polar anisotropy coefficient X.

As the polar anisotropy coefficient X increases, the orientation line (electron arrangement of the magnetic material) is concentrated around the circumferential direction of the pole region, the rigidity of both ends of the circumferential direction of the pole region is weakened, which may cause cracks to occur in the magnet 162. In other words, when the polar anisotropy coefficient X continues to increase, cracks may occur in the magnet 162.

Specifically, when the polar anisotropy coefficient X reaches 7.5 in a case where the magnet 162 is a one-pole magnet, a crack may occur in the magnet 162, when the polar anisotropy coefficient X reaches 6 in a case where the magnet 162 is a two-pole magnet, a crack may occurs in the magnet 162, when the polar anisotropy coefficient X reaches 4.5 in a case where the magnet 162 is a three-pole magnet, a crack may occur in the magnet 162, and when the polar anisotropy coefficient X reaches 3.5 in a case where the magnet 162 is a 4-pole magnet, a crack may occur in the magnet 162.

Therefore, it is preferable that the polar anisotropy coefficient X is less than 7.5 when the number of at least one pole regions 1622 and 1623 of the magnet 162 is one, the polar anisotropy coefficient X is less than six when the number of at least one pole regions 1624 and 1625 is two, the polar anisotropy coefficient X is less than 4.5 when the number of at least one pole regions 1626, 1627, and 1628 is three, and the polar anisotropy coefficient X is less than 3.5 when the number of at least one pole regions 1629, 1630, 1631, and 1632 is four.

Accordingly, it is possible to reduce the possibility of cracks occurring in the magnet 162 while increasing the counter electromotive force of the motor 150 and 160, and thus, it is possible to prevent the damage of the product.

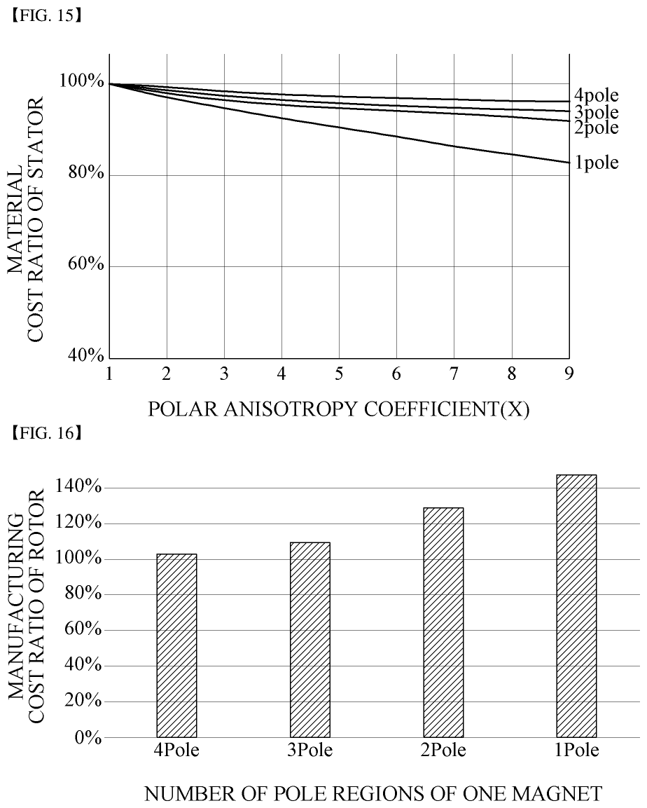

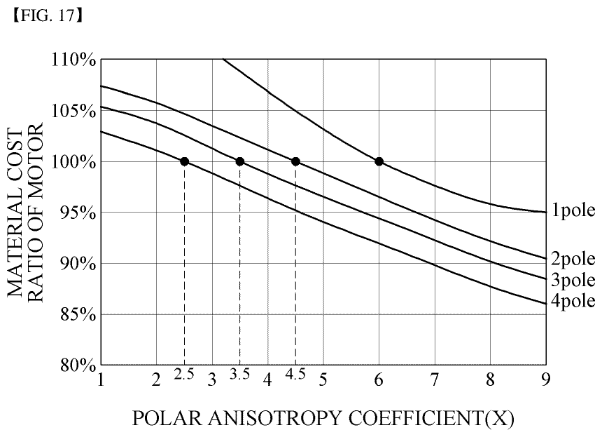

FIG. 15 is a graph illustrating a change rate of a material cost of the stator with respect to the polar anisotropy coefficient of the magnet according to one embodiment of the present disclosure. FIG. 16 is a graph illustrating a change rate of a rotor manufacturing cost with respect to the number of pole regions in one magnet according to one embodiment of the present disclosure. FIG. 17 is a graph illustrating the change rate of the material cost of the motor with respect to the polar anisotropy coefficient of the magnet according to one embodiment of the present disclosure. FIG. 18 is a graph illustrating the increase rate of the counter electromotive force of the motor with respect to the polar anisotropy coefficient of a magnet according to one embodiment of the present disclosure.

In FIG. 14, it was confirmed that the counter electromotive force of the motor 150 and 160 increases as the polar anisotropy coefficient X increases. In general, the counter electromotive force of the motor decreases as a stacking height of the stator core in the core of the same rotor 160 decreases.

When the polar anisotropy coefficient X is increased to 1 or more, the counter electromotive force can be made equivalent to the level when the polar anisotropy coefficient X is 1 by reducing the stacking height of the stator core. In other words, when the polar anisotropy coefficient X is set to 1 or more, the material cost of the stator can be reduced by reducing the stacking height of the stator core.

Referring to FIG. 15, the change rate of the material cost of the stator of the motor 150 and 160 according to the polar anisotropy coefficient X of the motor 150 and 160 can be known. As the polar anisotropy coefficient X increases, the counter electromotive force of the motor 150 and 160 increases, the stacking of the stator of the motor 150 and 160 can be reduced, and thus, the material cost of the stator can be reduced. Here, the material cost ratio of the stator means the ratio of the stator material cost when the polar anisotropy coefficient X changes to the stator material cost when the polar anisotropy coefficient X is set to 1.

Referring to FIG. 16, the manufacturing cost ratio of the rotor 160 to the number of pole regions 1622, 1623, 1624, 1625, 1626, 1627, 1628, 1629, 1630, 1631, and 1632 in one magnet can be known. Here, the manufacturing cost ratio of the rotor 160 means the manufacturing cost of the rotor when the number of pole regions in one magnet 162 is less than six compared to the manufacturing cost of the rotor 160 when one magnet 162 includes six pole regions.

Even when the number of pole regions 1622, 1623, 1624, 1625, 1626, 1627, 1628, 1629, 1630, 1631, and 1632 of one magnet 162 in the rotor 160 of the same size changes, the overall mass of the magnet 162 in the rotor 160 does not change significantly.

However, as the number of pole regions 1622, 1623, 1624, 1625, 1626, 1627, 1628, 1629, 1630, 1631, and 1632 in one magnet 162 increases, the number of physical magnets 162 in the rotor 160 decreases. For example, 48 physical magnets 162 of the rotor 160 are required when one magnet 162 has one pole region 1622 or 1623, 24 physical magnets 162 of the rotor 160 are required when one magnet 162 has two pole regions 1624 and 1625, 16 physical magnets 162 of the rotor 160 are required when one magnet 162 has three pole regions 1626, 1627, and 1628, 12 physical magnets 162 of the rotor 160 are required when one magnet 162 has four pole regions 1629, 1630, 1631, and 1632, and 8 physical magnets 162 of the rotor 160 are required when one magnet 162 has six pole regions.

As the number of physical magnets 162 of the rotor 160 increases, the number of work tasks required to attach the magnets 162 to the inside of the rotor core 164 increases, and thus, the work cost increases accordingly. In other words, as the number of pole regions 1622, 1623, 1624, 1625, 1626, 1627, 1628, 1629, 1630, 1631, and 1632 of one magnet 162 decreases, the manufacturing cost of the rotor 160 increases.

Referring to FIG. 17, the material cost ratio of the motor 150 and 160 to the polar anisotropy coefficient X of the magnet 162 can be known. The material cost of the motor 150 and 160 can be understood as including the material cost of the stator described in FIG. 15 and the manufacturing cost of the rotor 160 described in FIG. 16.

In FIG. 17, based on 100% of the material cost of the motor 150 and 160, it can be seen that the polar anisotropy coefficient X is 6 when one magnet 162 has one pole region 1622 or 1623, the polar anisotropy coefficient X is 4.5 when one magnet has two pole regions 1624 and 1625, the polar anisotropy coefficient X is 3.5 when one magnet 162 has three pole regions 1626, 1627, and 1628, and the polar anisotropy coefficient X is 2.5 when the magnet 162 has four pole regions 1629, 1630, 1631, and 1632.

It can be seen that the material cost of the motor 150 and 160 is reduced to less than 100% when the polar anisotropy coefficient X exceeds 6 in a case where the number of at least one pole regions 1622 and 1623 is one, the polar anisotropy coefficient X exceeds 4.5 in a case where the number of at least one pole regions 1624 and 1625 is two, the polar anisotropy coefficient X exceeds 3.5 in a case where the number of at least one pole regions 1626, 1627, and 1628 is three, and the polar anisotropy coefficient X exceeds 2.5 in a case where the number of at least one pole regions 1629, 1630, 1631, and 1632 is four. This means the lowest threshold for setting the polar anisotropy coefficient X within the limited material cost of the motor 150 and 160.

Therefore, referring to FIG. 18, considering the limited material cost of the motor 150 and 160 without cracking in the magnet 162, the orientation of the magnet 162 having the most optimal polar anisotropy coefficient X can be realized when the polar anisotropy coefficient X is between 6 and 7.5 in a case where the number of at least one pole regions 1622 and 1623 is one, when the polar anisotropy coefficient X is between 4.5 and 6 in a case where the number of at least one pole regions 1624 and 1625 is two, when the polar anisotropy coefficient X is between 3.5 and 4.5 in a case where the number of at least one pole regions 1626, 1627, and 1628 is three, and when the polar anisotropy coefficient X is between 2.5 and 3.5 in a case where the number of at least one pole regions 1629, 1630, 1631, and 1632 is four.

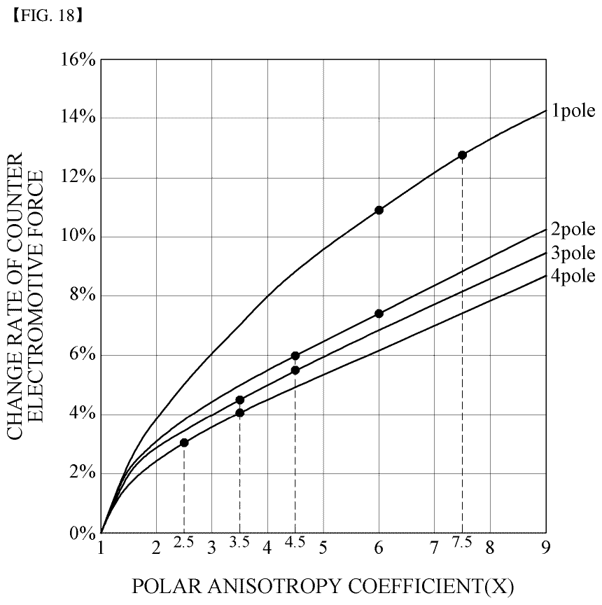

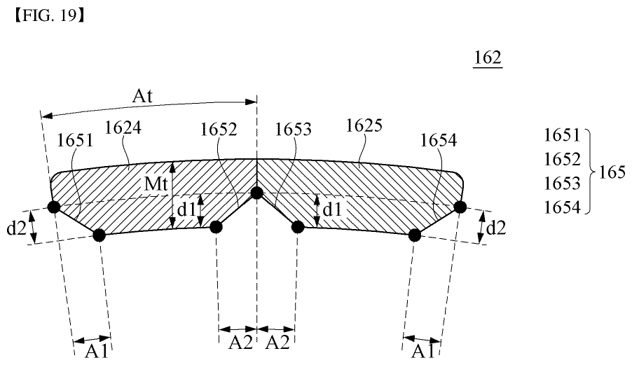

FIGS. 19 to 21 are plan views of a magnet according to one embodiment of the present disclosure.

Referring to FIGS. 19 to 21, the magnet 162 according to one embodiment of the present disclosure may include a plurality of pole regions 1624 and 1625. The magnet 162 may be formed in an arc shape. The plurality of pole regions 1624 and 1625 may be arranged in a circumferential direction.

A chamfer 165 may be formed on the inner surface of both ends of the pole regions 1624 and 1625. Accordingly, a cogging torque of the motor 150 and 160 may be reduced and the counter electromotive force of the motor 150 and 160 may be improved. Here, the cogging torque refers to a force that prevents the rotation of the rotor 160 when the rotor 160 tries to rotate, and may be generated by a force acting between the magnet 162 of the rotor 160 and the stator of the stator 150.

With reference to FIG. 19, the chamfer 165 of the third pole region 1624 may include an outer chamfer 1651 positioned on the left and an inner chamfer 1652 positioned on the right, and the chamfer 165 of the fourth pole region 1625 may include an inner chamfer 1653 positioned on the left and an outer chamfer 1654 positioned on the right. The inner chamfer 1652 of the third pole region 1624 and the inner chamfer 1653 of the fourth pole region 1625 may be connected to each other. The inner chamfer 1652 of the third pole region 1624 and the inner chamfer 1653 of the fourth pole region 1625 may be formed in shapes that are symmetrical to each other. The outer chamfer 1651 of the third pole region 1624 and the outer chamfer 1654 of the fourth pole region 1625 may be formed in shapes that are symmetrical to each other.

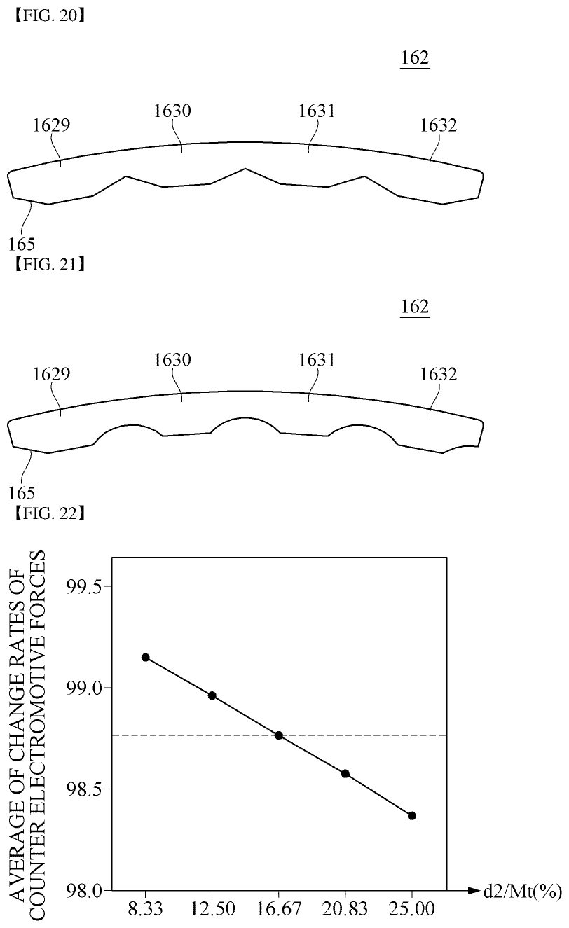

In FIG. 19, the case where the number of a plurality of pole regions 1624 and 1625 is two and the number of chamfers 2 of each of the pole regions 1624 and 1625 is two is explained as an example, but as in FIGS. 20 and 21, the number of pole regions 1629, 1630, 1631, and 1632 may be four and the number of chamfers 165 of each of the pole region 1629, 1630, 1631, and 1632 may be two, and the number of pole regions may be three or five or more.

In addition, as in FIG. 20, a cross-section of the chamfer 165 may be formed in a straight-line shape, or as in FIG. 21, the cross-section of the chamfer 165 may be formed in a curve shape. In FIG. 21, the cross-section of the chamfer 165 may be a curve shape concave radially outward, but may also be a curve shape convex radially inward.

Here, the radially outward direction may mean an up direction based on FIGS. 19 to 21, the radially inward direction may mean a down direction based on FIGS. 19 to 21, and a circumferential direction may mean as the left or right direction.

FIG. 22 is a graph illustrating an average of change rates of the counter electromotive forces of the motor according to a percentage obtained by dividing a radial length of the outer chamfer of the pole region of the magnet by a radial length of the pole region according to one embodiment of the present disclosure.

Referring to FIG. 22, the average of the change rates of the counter electromotive forces of the motor 150 and 160 according to the percentage obtained by dividing the radial lengths d2 of the outer chamfers 1651 and 1654 of the pole regions 1624 and 1625 of the magnet 162 by the radial lengths Mt of the pole regions 1624 and 1625 can be known. In other words, it can be seen that the counter electromotive force of the motor 150 and 160 decreases as the radial lengths d2 of the outer chamfers 1651 and 1654 increases.

Here, the change rate of counter electromotive force can be interpreted as the counter electromotive force of the motor 150 and 160 when there is the chamfer 165 in the magnet 162 compared to the counter electromotive force of the motor 150 and 160 when there is no chamfer 165 in the magnet 162.

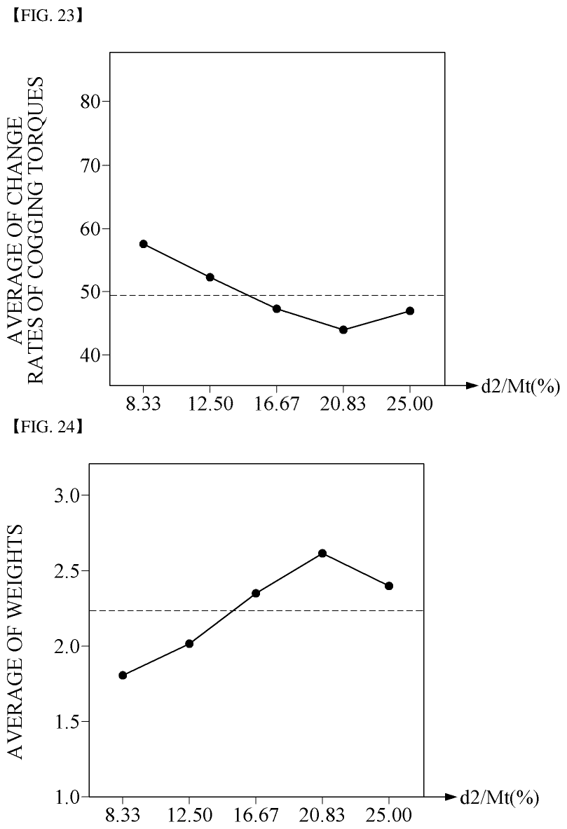

FIG. 23 is a graph illustrating an average of change rates of cogging torques of the motor according to a percentage obtained by dividing the radial length of the outer chamfer of the pole region of the magnet by the radial length of the pole region according to one embodiment of the present disclosure.

Referring to FIG. 23, the average of the change rates of the clogging torques of the motor 150 and 160 according to the percentage obtained by dividing the radial lengths d2 of the outer chamfers 1651 and 1654 of the pole regions 1624 and 1625 of the magnet 162 by the radial lengths Mt of the pole regions 1624 and 1625 can be known. That is, the cogging torque of the motor 150 and 160 decreases as the radial lengths d2 of the outer chamfers 1651 and 1654 increases. When the value obtained by dividing the radial lengths d2 of the outer chamfers 1651 and 1654 of the pole regions 1624 and 1625 of the magnet 162 by the radial lengths Mt of the pole regions 1624 and 1625 is 0.2083, the cogging torque of the motor 150 and 160 is minimized and when the radial lengths d2 of the outer chamfers 1651 and 1654 increases further, the cogging torque of the motor 150 and 160 increases again.

Here, the change rate of the cogging torque can be interpreted as the cogging torque of the motor 150 and 160 when the magnet 162 has the chamfer 165 compared to the cogging torque of the motor 150 and 160 when the magnet 162 does not have the chamfer 165.

FIG. 24 is a graph illustrating an average of weights of the motor according to a percentage obtained by dividing the radial length of the outer chamfer of the pole region of the magnet by the radial length of the pole region according to one embodiment of the present disclosure.

Referring to FIG. 24, an average of the weights of the motor 150 and 160 according to the percentage obtained by dividing the radial lengths d2 of the outer chamfers 1651 and 1654 of the pole regions 1624 and 1625 of the magnet 162 by the radial lengths Mt of the pole regions 1624 and 1625 can be known. Here, the weight of the motor 150 and 160 means a value obtained by dividing the change rate of the counter electromotive force of the motor 150 and 160 by the change rate of the cogging torque of the motor 150 and 160.

That is, the weight of the motor 150 and 160 increases as the radial lengths d2 of the outer chamfers 1651 and 1654 increase. When a value obtained by dividing the radial lengths d2 of the outer chamfers 1651 and 1654 of the pole regions 1624 and 1625 of the magnet 162 by the radial lengths Mt of the pole regions 1624 and 1625 is 0.2083, the weight of the motor 150 and 160 is maximum, and when the radial lengths d2 of the outer chamfers 1651 and 1654 increase further, the weight of the motor 150 and 160 decreases again.

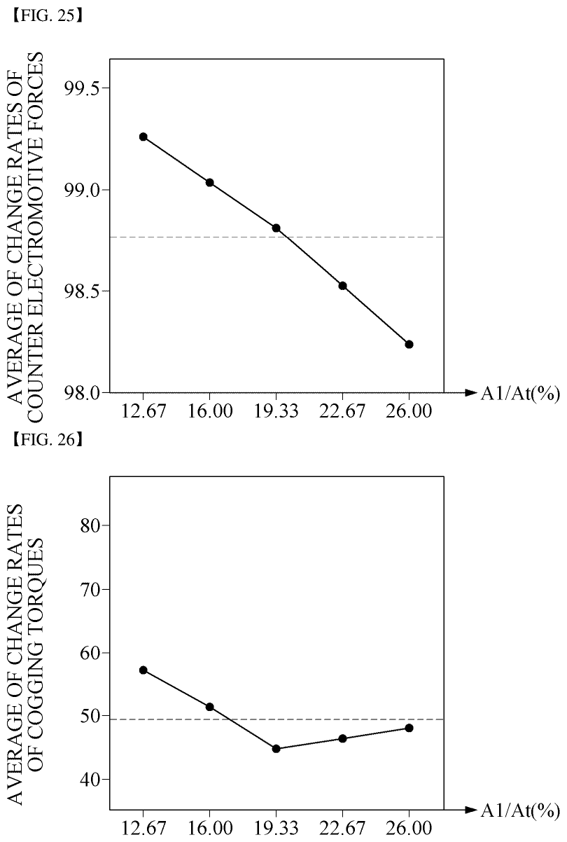

FIG. 25 is a graph illustrating an average of change rates of counter electromotive forces of the motor according to a percentage obtained by dividing a circumferential length of the outer chamfer of the pole region of the magnet by a circumferential length of the pole region according to one embodiment of the present disclosure.

Referring to FIG. 25, an average of change rates of counter electromotive forces of the motor 150 and 160 according to the percentage obtained by dividing circumferential lengths A1 of the outer chamfers 1651 and 1654 of the pole regions 1624 and 1625 of the magnet 162 by circumferential lengths At of the pole regions 1624 and 1625 can be known. That is, it can be seen that the counter electromotive force of the motor 150 and 160 decreases as the circumferential lengths A1 of the outer chamfers 1651 and 1654 increase.

FIG. 26 is a graph illustrating an average of change rates of cogging torques of the motor according to a percentage obtained by dividing the circumferential length of the outer chamfer of the pole region of the magnet by the circumferential length of the pole region according to one embodiment of the present disclosure.

Referring to FIG. 26, the average of the change rates of the clogging torques of the motor 150 and 160 according to the percentage obtained by dividing the circumferential lengths A1 of the outer chamfers 1651 and 1654 of the pole regions 1624 and 1625 of the magnet 162 by the circumferential lengths At of the pole regions 1624 and 1625 can be known. That is, the cogging torque of the motor 150 and 160 decreases as the circumferential lengths A1 of the outer chamfers 1651 and 1654 increase. When the value obtained by dividing the circumferential lengths A1 of the outer chamfers 1651 and 1654 of the pole regions 1624 and 1625 of the magnet 162 by the circumferential lengths At of the pole regions 1624 and 1625 is 0.1933, the cogging torque of the motor 150 and 160 is minimized and when the circumferential lengths A1 of the outer chamfers 1651 and 1654 increases further, the cogging torque of the motor 150 and 160 increases again.

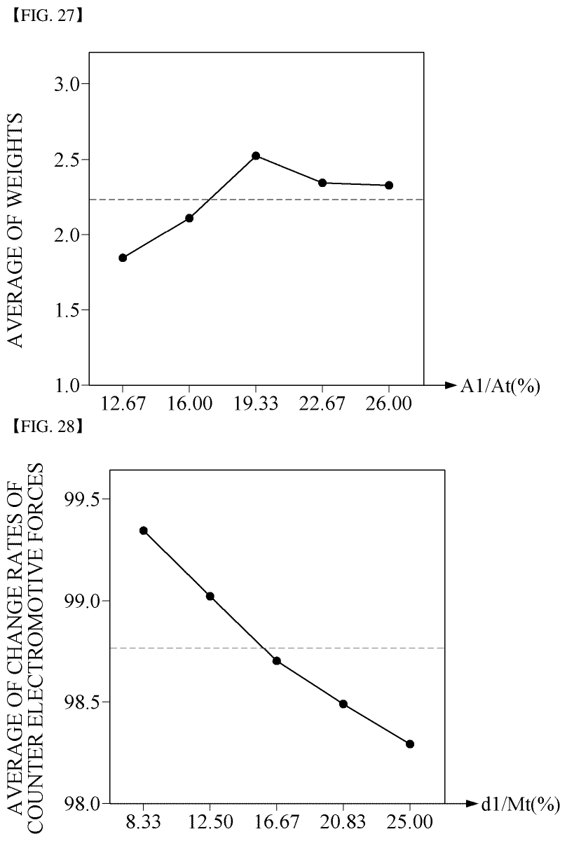

FIG. 27 is a graph illustrating an average of weights of the motor according to a percentage obtained by dividing the circumferential length of the outer chamfer of the pole region of the magnet by the circumferential length of the pole region according to one embodiment of the present disclosure.

Referring to FIG. 27, an average of the weights of the motor 150 and 160 according to the percentage obtained by dividing the circumferential lengths A1 of the outer chamfers 1651 and 1654 of the pole regions 1624 and 1625 of the magnet 162 by the circumferential lengths At of the pole regions 1624 and 1625 can be known.

That is, the weight of the motor 150 and 160 increases as the circumferential lengths A1 of the outer chamfers 1651 and 1654 increase. When a value obtained by dividing the circumferential lengths A1 of the outer chamfers 1651 and 1654 of the pole regions 1624 and 1625 of the magnet 162 by the circumferential lengths At of the pole regions 1624 and 1625 is 0.1933, the weight of the motor 150 and 160 is maximum, and when the circumferential lengths A1 of the outer chamfers 1651 and 1654 increase further, the weight of the motor 150 and 160 decreases again.

FIG. 28 is a graph illustrating an average of change rates of the counter electromotive forces of the motor according to a percentage obtained by dividing a radial length of the inner chamfer of the pole region of the magnet by a radial length of the pole region according to one embodiment of the present disclosure.

Referring to FIG. 28, the average of the change rates of the counter electromotive forces of the motor 150 and 160 according to the percentage obtained by dividing the radial lengths d1 of the inner chamfers 1652 and 1653 of the pole regions 1624 and 1625 of the magnet 162 by the radial lengths Mt of the pole regions 1624 and 1625 can be known. That is, it can be seen that the counter electromotive force of the motor 150 and 160 decreases as the radial lengths d1 of the inner chamfers 1652 and 1653 increases.

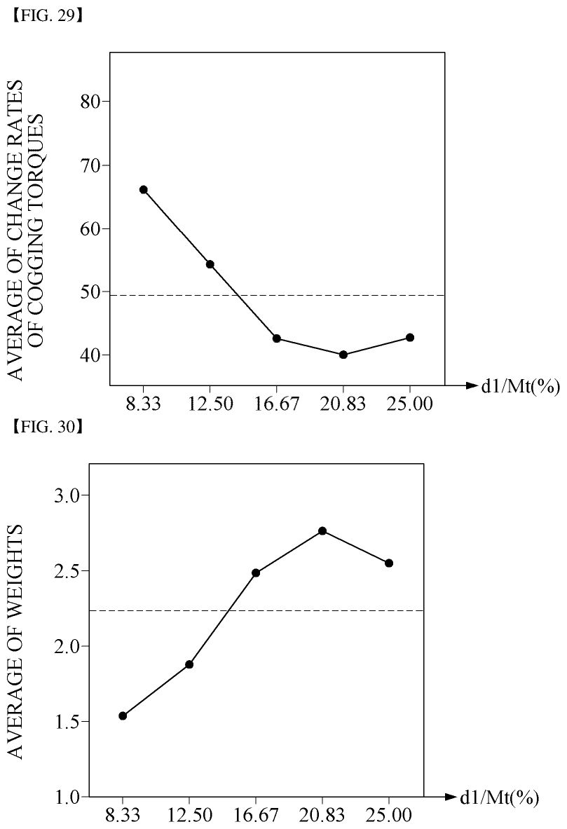

FIG. 29 is a graph illustrating an average of change rates of cogging torques of the motor according to a percentage obtained by dividing the radial length of the inner chamfer of the pole region of the magnet by the radial length of the pole region according to one embodiment of the present disclosure.

Referring to FIG. 29, the average of the change rates of the clogging torques of the motor 150 and 160 according to the percentage obtained by dividing the radial lengths d1 of the inner chamfers 1652 and 1653 of the pole regions 1624 and 1625 of the magnet 162 by the radial lengths Mt of the pole regions 1624 and 1625 can be known. That is, the cogging torque of the motor 150 and 160 decreases as the radial lengths d1 of the inner chamfers 1652 and 1653 increases. When the value obtained by dividing the radial lengths d1 of the inner chamfers 1652 and 1653 of the pole regions 1624 and 1625 of the magnet 162 by the radial lengths Mt of the pole regions 1624 and 1625 is 0.2083, the cogging torque of the motor 150 and 160 is minimized and when the radial lengths d1 of the outer chamfers 1652 and 1653 increases further, the cogging torque of the motor 150 and 160 increases again.

FIG. 30 is a graph illustrating an average of weights of the motor according to a percentage obtained by dividing the radial length of the inner chamfer of the pole region of the magnet by the radial length of the pole region according to one embodiment of the present disclosure.

Referring to FIG. 30, an average of the weights of the motor 150 and 160 according to the percentage obtained by dividing the radial lengths d1 of the inner chamfers 1652 and 1653 of the pole regions 1624 and 1625 of the magnet 162 by the radial lengths Mt of the pole regions 1624 and 1625 can be known.

That is, the weight of the motor 150 and 160 increases as the radial lengths d1 of the inner chamfers 1652 and 1653 increase. When a value obtained by dividing the radial lengths d1 of the inner chamfers 1652 and 1653 of the pole regions 1624 and 1625 of the magnet 162 by the radial lengths Mt of the pole regions 1624 and 1625 is 0.2083, the weight of the motor 150 and 160 is maximum, and when the radial lengths d1 of the inner chamfers 1652 and 1653 increase further, the weight of the motor 150 and 160 decreases again.

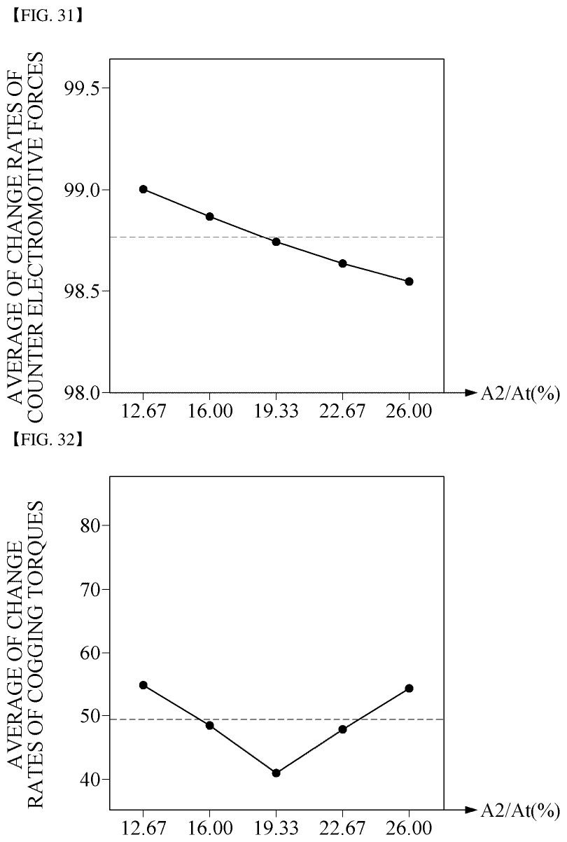

FIG. 31 is a graph illustrating an average of the change rates of the counter electromotive forces of the motor according to the percentage obtained by dividing the circumferential length of the inner chamfer of the pole region of the magnet by the circumferential length of the pole region according to one embodiment of the present disclosure.

Referring to FIG. 31, the average of the change rates of the counter electromotive forces of the motor 150 and 160 according to the percentage obtained by dividing circumferential lengths A2 of the inner chamfers 1652 and 1653 of the pole regions 1624 and 1625 of the magnet 162 by circumferential lengths At of the pole regions 1624 and 1625 can be known. That is, it can be seen that the counter electromotive force of the motor 150 and 160 decreases as the circumferential lengths A1 of the inner chamfers 1652 and 1653 increase.

FIG. 32 is a graph illustrating an average of change rates of cogging torques of the motor according to a percentage obtained by dividing the circumferential length of the inner chamfer of the pole region of the magnet by the circumferential length of the pole region according to one embodiment of the present disclosure.

Referring to FIG. 32, the average of the change rates of the clogging torques of the motor 150 and 160 according to the percentage obtained by dividing the circumferential lengths A2 of the inner chamfers 1652 and 1653 of the pole regions 1624 and 1625 of the magnet 162 by the circumferential lengths At of the pole regions 1624 and 1625 can be known. That is, the cogging torque of the motor 150 and 160 decreases as the circumferential lengths A2 of the inner chamfers 1652 and 1653 increase. When the value obtained by dividing the circumferential lengths A2 of the inner chamfers 1652 and 1653 of the pole regions 1624 and 1625 of the magnet 162 by the circumferential lengths At of the pole regions 1624 and 1625 is 0.1933, the cogging torque of the motor 150 and 160 is minimized and when the circumferential lengths A2 of the inner chamfers 1652 and 1653 increases further, the cogging torque of the motor 150 and 160 increases again.

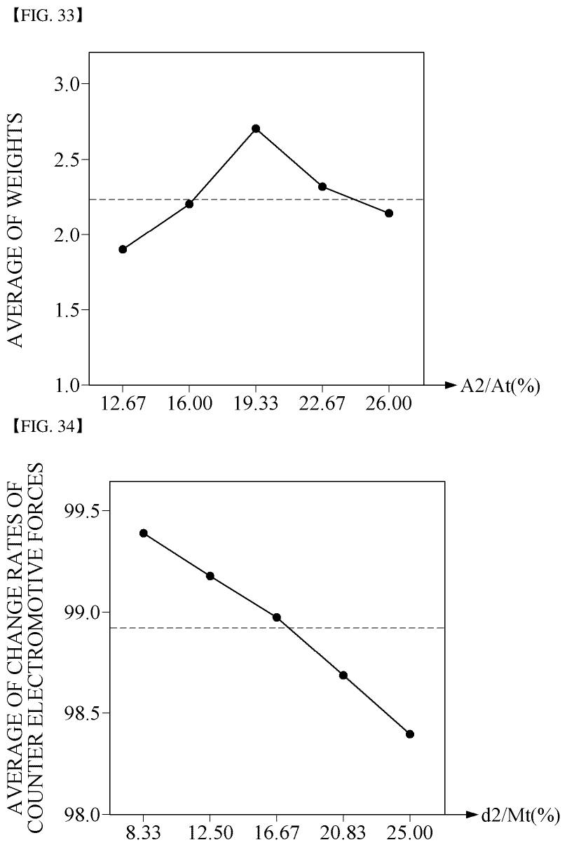

FIG. 33 is a graph illustrating an average of weights of the motor according to a percentage obtained by dividing the circumferential length of the inner chamfer of the pole region of the magnet by the circumferential length of the pole region according to one embodiment of the present disclosure.

Referring to FIG. 33, an average of the weights of the motor 150 and 160 according to the percentage obtained by dividing the circumferential lengths A2 of the inner chamfers 1652 and 1653 of the pole regions 1624 and 1625 of the magnet 162 by the circumferential lengths At of the pole regions 1624 and 1625 can be known.

That is, the weight of the motor 150 and 160 increases as the circumferential lengths A2 of the inner chamfers 1652 and 1653 increase. When a value obtained by dividing the circumferential lengths A2 of the inner chamfers 1652 and 1653 of the pole regions 1624 and 1625 of the magnet 162 by the circumferential lengths At of the pole regions 1624 and 1625 is 0.1933, the weight of the motor 150 and 160 is maximum, and when the circumferential lengths A1 of the inner chamfers 1652 and 1653 increase further, the weight of the motor 150 and 160 decreases again.

Referring to FIGS. 22 to 33, it can be confirmed that the weight of the motor 150 and 160 according to the change of the radial lengths d2 of the outer chamfers 1651 and 1654 corresponds to the weight of the motor 150 and 160 according to the change of the radial length d1 of the inner chamfers 1652 and 1653, and the weight of the motor 150 and 160 according to the change of the circumferential length A1 of the outer chamfers 1651 and 1654 corresponds to the weight of the motor 150 and 160 according to the change of the circumferential length A2 of the inner chamfers 1652 and 1653, so that the inner chamfers 1652 and 1653 and the outer chamfers 1651 and 1654 do not need to be distinguished separately.

That is, the value obtained by dividing the radial lengths d1 and d2 of the chamfer 165 by the radial lengths Mt of the pole regions 1624 and 1625 may be between 0.20 and 0.21. Preferably, the value obtained by dividing the radial lengths d1 and d2 of the chamfer 165 by the radial lengths Mt of the pole regions 1624 and 1625 may be between 0.208 and 0.209. More preferably, the value obtained by dividing the radial lengths d1 and d2 of the chamfer 165 by the radial lengths Mt of the pole region 1624 and 1625 may be 0.2083.

In addition, the value obtained by dividing the circumferential lengths A1 and A2 of the chamfer 165 by the circumferential length At of the pole region 1624 and 1625 may be between 0.19 and 0.20. Preferably, the value obtained by dividing the circumferential lengths A1 and A2 of the chamfer 165 by the circumferential length At of the pole region 1624 and 1625 may be between 0.193 and 0.194. More preferably, the value obtained by dividing the circumferential lengths A1 and A2 of the chamfer 165 by the circumferential length At of the pole region 1624 and 1625 may be 0.1933.

Therefore, the efficiency of the counter electromotive force of the motor 150 and 160 can be improved compared to the cogging torque of the motor 150 and 160.

In FIGS. 22 to 33, the case where the number of the plurality of pole regions 1624 and 1625 is two is described, but this can also be applied to the case where the number of the plurality of pole regions 1624 and 1625 is three or more.

In FIGS. 22 to 33, a case where the plurality of pole regions 1624 and 1625 have the same magnetic focus center as the center O of the inner diameter ri of the plurality of pole regions 1624 and 1625, that is, a case where the magnetic focus center of the magnet 162 is not polarly anisotropic, is described.

Hereinafter, in FIGS. 34 to 45, a case where the plurality of pole regions 1624 and 1625 do not have the same magnetic focus center as the center O of the inner diameter ri of the plurality of pole regions 1624 and 1625, that is, a case where the magnetic focus center of the magnet 162 is polarly anisotropic, is described. In other words, it explains the case where each of the plurality of pole regions 1624 and 1625 has a separate magnetic focus center b3 or b4.

FIG. 34 is a graph illustrating the average of the change rates of the counter electromotive forces of the motor according to the percentage obtained by dividing the radial length of the outer chamfer of the pole region of the magnet by the radial length of the pole region according to one embodiment of the present disclosure.

Referring to FIG. 34, the average of the change rates of the counter electromotive forces of the motor 150 and 160 according to the percentage obtained by dividing the radial lengths d2 of the outer chamfers 1651 and 1654 of the pole regions 1624 and 1625 of the magnet 162 by the radial lengths Mt of the pole regions 1624 and 1625 can be known. That is, it can be seen that the counter electromotive force of the motor 150 and 160 decreases as the radial lengths d2 of the outer chamfers 1651 and 1654 increases.

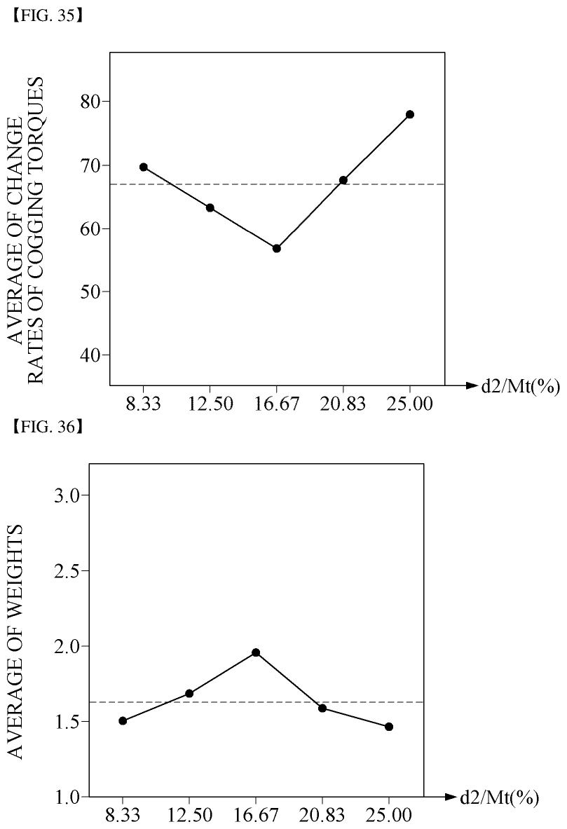

FIG. 35 is a graph illustrating the average of the change rates of the cogging torques of the motor according to the percentage obtained by dividing the radial length of the outer chamfer of the pole region of the magnet by the radial length of the pole region according to one embodiment of the present disclosure.

Referring to FIG. 35, the average of the change rates of the clogging torques of the motor 150 and 160 according to the percentage obtained by dividing the radial lengths d2 of the outer chamfers 1651 and 1654 of the pole regions 1624 and 1625 of the magnet 162 by the radial lengths Mt of the pole regions 1624 and 1625 can be known. That is, the cogging torque of the motor 150 and 160 decreases as the radial lengths d2 of the outer chamfers 1651 and 1654 increases. When the value obtained by dividing the radial lengths d2 of the outer chamfers 1651 and 1654 of the pole regions 1624 and 1625 of the magnet 162 by the radial lengths Mt of the pole regions 1624 and 1625 is 0.1667, the cogging torque of the motor 150 and 160 is minimized and when the radial lengths d2 of the outer chamfers 1651 and 1654 increases further, the cogging torque of the motor 150 and 160 increases again.

FIG. 36 is a graph illustrating the average of weights of the motor according to the percentage obtained by dividing the radial length of the outer chamfer of the pole region of the magnet by the radial length of the pole region according to one embodiment of the present disclosure.

Referring to FIG. 36, the average of the weights of the motor 150 and 160 according to the percentage obtained by dividing the radial lengths d2 of the outer chamfers 1651 and 1654 of the pole regions 1624 and 1625 of the magnet 162 by the radial lengths Mt of the pole regions 1624 and 1625 can be known.

That is, the weight of the motor 150 and 160 increases as the radial lengths d2 of the outer chamfers 1651 and 1654 increase. When the value obtained by dividing the radial lengths d2 of the outer chamfers 1651 and 1654 of the pole regions 1624 and 1625 of the magnet 162 by the radial lengths Mt of the pole regions 1624 and 1625 is 0.1667, the weight of the motor 150 and 160 is maximum, and when the radial lengths d2 of the outer chamfers 1651 and 1654 increase further, the weight of the motor 150 and 160 decreases again.

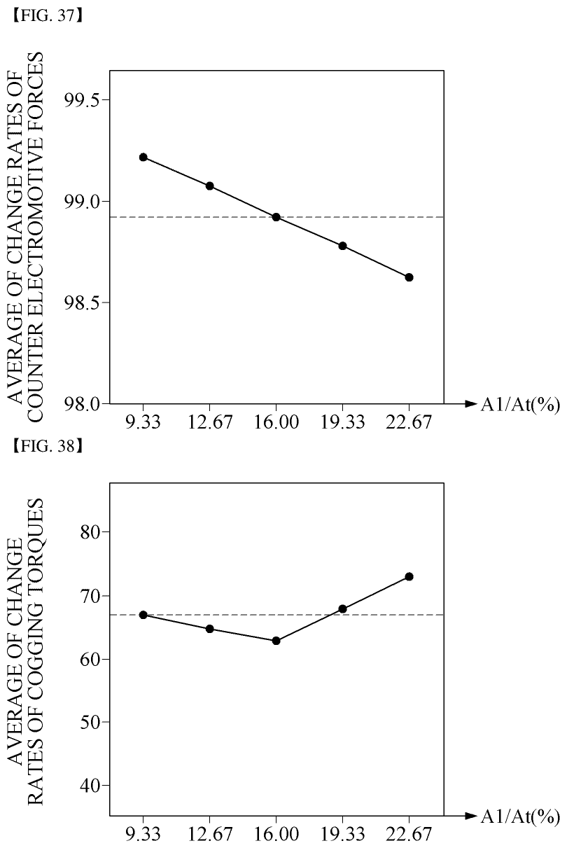

FIG. 37 is a graph illustrating the average of the change rates of the counter electromotive forces of the motor according to the percentage obtained by dividing the circumferential length of the outer chamfer of the pole region of the magnet by the circumferential length of the pole region according to one embodiment of the present disclosure.

Referring to FIG. 37, the average of the change rates of the counter electromotive forces of the motor 150 and 160 according to the percentage obtained by dividing circumferential lengths A1 of the outer chamfers 1651 and 1654 of the pole regions 1624 and 1625 of the magnet 162 by circumferential lengths At of the pole regions 1624 and 1625 can be known. That is, it can be seen that the counter electromotive force of the motor 150 and 160 decreases as the circumferential lengths A1 of the outer chamfers 1651 and 1654 increase.

FIG. 38 is a graph illustrating the average of the change rates of the cogging torques of the motor according to the percentage obtained by dividing the circumferential length of the outer chamfer of the pole region of the magnet by the circumferential length of the pole region according to one embodiment of the present disclosure.

Referring to FIG. 38, the average of the change rates of the clogging torques of the motor 150 and 160 according to the percentage obtained by dividing the circumferential lengths A1 of the outer chamfers 1651 and 1654 of the pole regions 1624 and 1625 of the magnet 162 by the circumferential lengths At of the pole regions 1624 and 1625 can be known. That is, the cogging torque of the motor 150 and 160 decreases as the circumferential lengths A1 of the outer chamfers 1651 and 1654 increase. When the value obtained by dividing the circumferential lengths A1 of the outer chamfers 1651 and 1654 of the pole regions 1624 and 1625 of the magnet 162 by the circumferential lengths At of the pole regions 1624 and 1625 is 0.16, the cogging torque of the motor 150 and 160 is minimized and when the circumferential lengths A1 of the outer chamfers 1651 and 1654 increases further, the cogging torque of the motor 150 and 160 increases again.

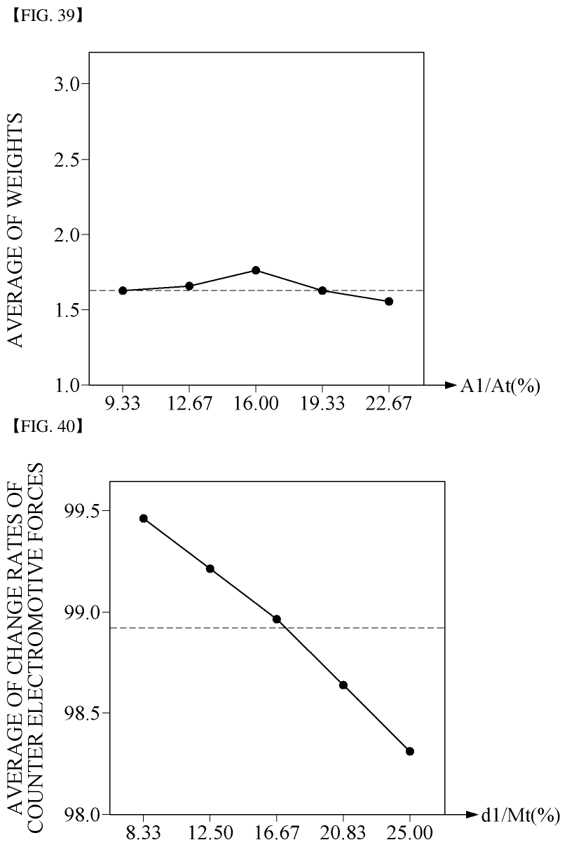

FIG. 39 is a graph illustrating the average of weights of the motor according to the percentage obtained by dividing the circumferential length of the outer chamfer of the pole region of the magnet by the circumferential length of the pole region according to one embodiment of the present disclosure.

The average of the weights of the motor 150 and 160 according to the percentage obtained by dividing the circumferential lengths A1 of the outer chamfers 1651 and 1654 of the pole regions 1624 and 1625 of the magnet 162 by the circumferential lengths At of the pole regions 1624 and 1625 can be known.

That is, the weight of the motor 150 and 160 increases as the circumferential lengths A1 of the outer chamfers 1651 and 1654 increase. When the value obtained by dividing the circumferential lengths A1 of the outer chamfers 1651 and 1654 of the pole regions 1624 and 1625 of the magnet 162 by the circumferential lengths At of the pole regions 1624 and 1625 is 0.16, the weight of the motor 150 and 160 is maximum, and when the circumferential lengths A1 of the outer chamfers 1651 and 1654 increase further, the weight of the motor 150 and 160 decreases again.

FIG. 40 is a graph illustrating the average of change rates of the counter electromotive forces of the motor according to the percentage obtained by dividing the radial length of the inner chamfer of the pole region of the magnet by the radial length of the pole region according to one embodiment of the present disclosure.

Referring to FIG. 40, the average of the change rates of the counter electromotive forces of the motor 150 and 160 according to the percentage obtained by dividing the radial lengths d1 of the inner chamfers 1652 and 1653 of the pole regions 1624 and 1625 of the magnet 162 by the radial lengths Mt of the pole regions 1624 and 1625 can be known. That is, it can be seen that the counter electromotive force of the motor 150 and 160 decreases as the radial lengths d1 of the inner chamfers 1652 and 1653 increases.

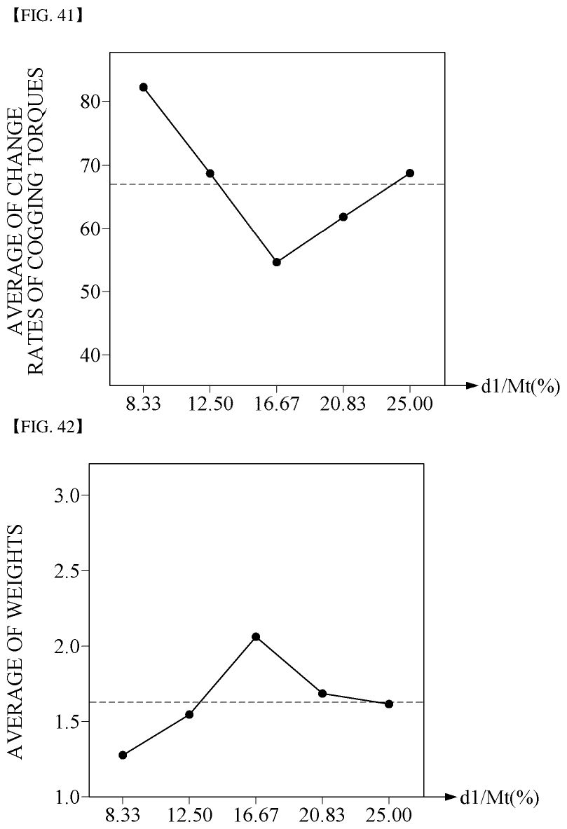

FIG. 41 is a graph illustrating the average of the change rates of the cogging torques of the motor according to a percentage obtained by dividing the radial length of the inner chamfer of the pole region of the magnet by the radial length of the pole region according to one embodiment of the present disclosure.

Referring to FIG. 41, the average of the change rates of the clogging torques of the motor 150 and 160 according to the percentage obtained by dividing the radial lengths d1 of the inner chamfers 1652 and 1653 of the pole regions 1624 and 1625 of the magnet 162 by the radial lengths Mt of the pole regions 1624 and 1625 can be known. That is, the cogging torque of the motor 150 and 160 decreases as the radial lengths d1 of the inner chamfers 1652 and 1653 increases. When the value obtained by dividing the radial lengths d1 of the inner chamfers 1652 and 1653 of the pole regions 1624 and 1625 of the magnet 162 by the radial lengths Mt of the pole regions 1624 and 1625 is 0.1667, the cogging torque of the motor 150 and 160 is minimized and when the radial lengths d1 of the outer chamfers 1652 and 1653 increases further, the cogging torque of the motor 150 and 160 increases again.

FIG. 42 is a graph illustrating the average of the weights of the motor according to the percentage obtained by dividing the radial length of the inner chamfer of the pole region of the magnet by the radial length of the pole region according to one embodiment of the present disclosure.

Referring to FIG. 42, the average of the weights of the motor 150 and 160 according to the percentage obtained by dividing the radial lengths d1 of the inner chamfers 1652 and 1653 of the pole regions 1624 and 1625 of the magnet 162 by the radial lengths Mt of the pole regions 1624 and 1625 can be known.

That is, the weight of the motor 150 and 160 increases as the radial lengths d1 of the inner chamfers 1652 and 1653 increase. When the value obtained by dividing the radial lengths d1 of the inner chamfers 1652 and 1653 of the pole regions 1624 and 1625 of the magnet 162 by the radial lengths Mt of the pole regions 1624 and 1625 is 0.1667, the weight of the motor 150 and 160 is maximum, and when the radial lengths d1 of the inner chamfers 1652 and 1653 increase further, the weight of the motor 150 and 160 decreases again.

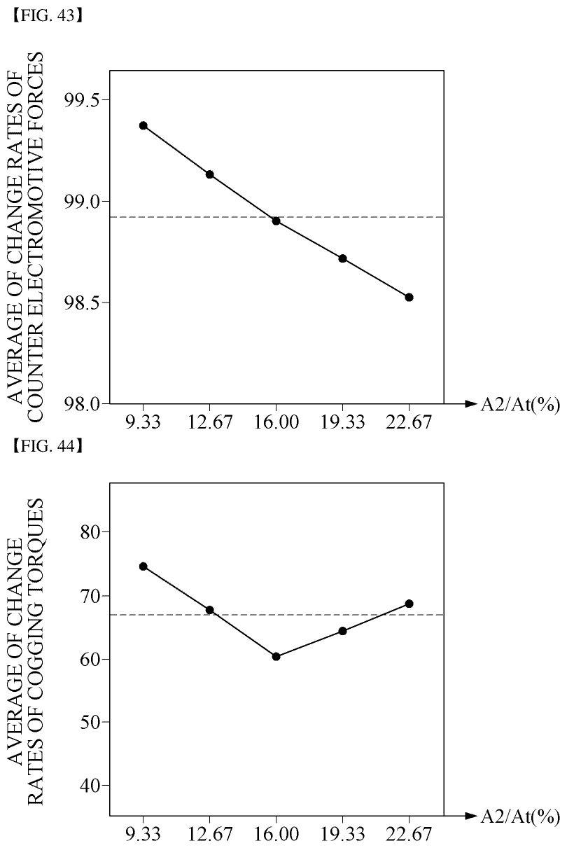

FIG. 43 is a graph illustrating the average of the change rates of the counter electromotive forces of the motor according to the percentage obtained by dividing the circumferential length of the inner chamfer of the pole region of the magnet by the circumferential length of the pole region according to one embodiment of the present disclosure.

Referring to FIG. 43, the average of the change rates of the counter electromotive forces of the motor 150 and 160 according to the percentage obtained by dividing circumferential lengths A2 of the inner chamfers 1652 and 1653 of the pole regions 1624 and 1625 of the magnet 162 by circumferential lengths At of the pole regions 1624 and 1625 can be known. That is, it can be seen that the counter electromotive force of the motor 150 and 160 decreases as the circumferential lengths A1 of the inner chamfers 1652 and 1653 increase.

FIG. 44 is a graph illustrating the average of the change rates of the cogging torques of the motor according to the percentage obtained by dividing the circumferential length of the inner chamfer of the pole region of the magnet by the circumferential length of the pole region according to one embodiment of the present disclosure.

Referring to FIG. 44, the average of the change rates of the clogging torques of the motor 150 and 160 according to the percentage obtained by dividing the circumferential lengths A2 of the inner chamfers 1652 and 1653 of the pole regions 1624 and 1625 of the magnet 162 by the circumferential lengths At of the pole regions 1624 and 1625 can be known. That is, the cogging torque of the motor 150 and 160 decreases as the circumferential lengths A2 of the inner chamfers 1652 and 1653 increase. When the value obtained by dividing the circumferential lengths A2 of the inner chamfers 1652 and 1653 of the pole regions 1624 and 1625 of the magnet 162 by the circumferential lengths At of the pole regions 1624 and 1625 is 0.16, the cogging torque of the motor 150 and 160 is minimized and when the circumferential lengths A2 of the inner chamfers 1652 and 1653 increases further, the cogging torque of the motor 150 and 160 increases again.

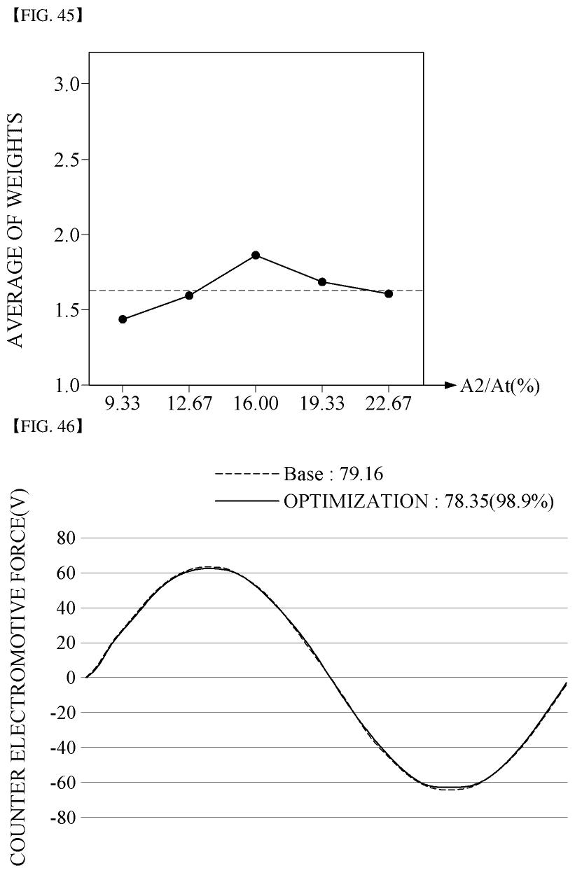

FIG. 45 is a graph illustrating the average of weights of the motor according to the percentage obtained by dividing the circumferential length of the inner chamfer of the pole region of the magnet by the circumferential length of the pole region according to one embodiment of the present disclosure.

Referring to FIG. 45, the average of the weights of the motor 150 and 160 according to the percentage obtained by dividing the circumferential lengths A2 of the inner chamfers 1652 and 1653 of the pole regions 1624 and 1625 of the magnet 162 by the circumferential lengths At of the pole regions 1624 and 1625 can be known.

That is, the weight of the motor 150 and 160 increases as the circumferential lengths A2 of the inner chamfers 1652 and 1653 increase. When the value obtained by dividing the circumferential lengths A2 of the inner chamfers 1652 and 1653 of the pole regions 1624 and 1625 of the magnet 162 by the circumferential lengths At of the pole regions 1624 and 1625 is 0.16, the weight of the motor 150 and 160 is maximum, and when the circumferential lengths A1 of the inner chamfers 1652 and 1653 increase further, the weight of the motor 150 and 160 decreases again.

Referring to FIGS. 34 to 45, it can be confirmed that, even when the plurality of pole regions 1624 and 1625 have respective magnetic focus centers b3 and b4 that are different from the centers O of the inner diameters ri of the plurality of pole regions 1624 and 1625, the weight of the motor 150 and 160 according to the change of the radial lengths d2 of the outer chamfers 1651 and 1654 corresponds to the weight of the motor 150 and 160 according to the change of the radial length d1 of the inner chamfers 1652 and 1653, and the weight of the motor 150 and 160 according to the change of the circumferential length A1 of the outer chamfers 1651 and 1654 corresponds to the weight of the motor 150 and 160 according to the change of the circumferential length A2 of the inner chamfers 1652 and 1653, so that the inner chamfers 1652 and 1653 and the outer chamfers 1651 and 1654 do not need to be distinguished separately.

That is, the value obtained by dividing the radial lengths d1 and d2 of the chamfer 165 by the radial lengths Mt of the pole regions 1624 and 1625 may be between 0.16 and 0.17. Preferably, the value obtained by dividing the radial lengths d1 and d2 of the chamfer 165 by the radial lengths Mt of the pole regions 1624 and 1625 may be between 0.166 and 0.167. More preferably, the value obtained by dividing the radial lengths d1 and d2 of the chamfer 165 by the radial lengths Mt of the pole region 1624 and 1625 may be 0.1667.

In addition, the value obtained by dividing the circumferential lengths A1 and A2 of the chamfer 165 by the circumferential length At of the pole region 1624 and 1625 may be between 0.155 and 0.165. Preferably, the value obtained by dividing the circumferential lengths A1 and A2 of the chamfer 165 by the circumferential length At of the pole region 1624 and 1625 may be between 0.1595 and 0.1605. More preferably, the value obtained by dividing the circumferential lengths A1 and A2 of the chamfer 165 by the circumferential length At of the pole region 1624 and 1625 may be 0.16.

Therefore, the efficiency of the counter electromotive force of the motor 150 and 160 can be improved compared to the cogging torque of the motor 150 and 160.

Referring to FIGS. 22 to 45, it can be seen that when the magnetic focus center of the magnet 162 is polarly anisotropic, the same efficiency is exhibited even when the radial lengths d1 and d2 and circumferential lengths A1 and A2 of the chamfer 165 are smaller than when the magnetic focus center is not polarly anisotropic.

That is, when the chamfer 165 is present in the magnet 162, it can be seen that the efficiency of the counter electromotive force of the motor 150 and 160 increases compared to the cogging torque of the motor 150 and 160 as the polar anisotropy coefficient X increases. However, in order to prevent damage to the magnet 162, it is preferable that the polar anisotropy coefficient X is less than 6 when the number of the plurality of regions 1624 and 1625 is two, the polar anisotropy coefficient X is less than 4.5 when the number of the plurality of pole regions 1626, 1627, and 1628 is three, and the polar anisotropy coefficient X is less than 3.5 when the number of the plurality of pole regions 1629, 1630, and 1631 is four.

In FIGS. 34 to 45, the case where the number of pole regions 1624 and 1625 is two is described, but this can also be applied to the case where the number of pole regions 1624 and 1625 is three or more.

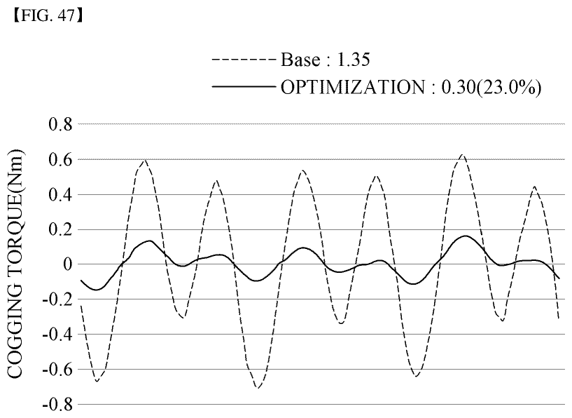

FIG. 46 is a graph illustrating counter electromotive forces of motors according to the prior art and one embodiment of the present disclosure.

Referring to FIG. 46, it can be seen that the counter electromotive force of the motor 150 and 160 is substantially the same at 98.9% in the case of the motor (optimization) having the magnet 162 according to one embodiment of the present disclosure compared to the base without the chamfer.

FIG. 47 is a graph illustrating cogging torques of the motors according to the prior art and one embodiment of the present disclosure.

Referring to FIG. 47, it can be seen that the cogging torque of the motor 150 and 160 is significantly reduced to 23% in the case of the motor (optimization) having the magnet 162 according to one embodiment of the present disclosure compared to the base without a chamfer.

The embodiments or other embodiments of the present disclosure described above are not mutually exclusive or distinct. The embodiments or other embodiments of the present disclosure described above may be combined or used in combination with each other in their respective configurations or functions.

For example, it means that A configuration described in a specific embodiment and/or the drawings and B configuration described in another embodiment and/or the drawings can be coupled. That is, even when the coupling between the configurations is not directly described, it means that the coupling is possible except in cases where the coupling is described as impossible.

The above detailed description should not be construed as limiting in all respects and should be considered exemplary. The scope of the present disclosure should be determined by a reasonable interpretation of the appended claims, and all changes within the equivalent scope of the present disclosure are included in the scope of the present disclosure.

1. A magnet comprising a plurality of pole regions formed in an arc shape and arranged in parallel in a circumferential direction,
wherein chamfers formed on inner surfaces of both ends of the pole region, and
a value obtained by dividing a radial length of the chamfer by a radial length of the pole region is between 0.20 and 0.21.

2. The magnet of claim 1, wherein the value obtained by dividing the radial length of the chamfer by the radial length of the pole region is between 0.208 and 0.209.

3. The magnet of claim 1, wherein a value obtained by dividing a circumferential length of the chamber by a circumferential length of the pole region is between 0.19 and 0.20.

4. The magnet of claim 3, wherein the value obtained by dividing the circumferential length of the chamber by the circumferential length of the pole region is between 0.193 and 0.194.

5. The magnet of claim 1, wherein a cross section of the chamber is formed as a straight line or a curve.

6. A magnet comprising a plurality of pole regions formed in an arc shape and arranged in parallel in a circumferential direction,
wherein chamfers formed on inner surfaces of both ends of the pole region, and
a value obtained by dividing a circumferential length of the chamfer by a circumferential length of the pole region is between 0.19 and 0.20.

7. The magnet of claim 6, wherein the value obtained by dividing the circumferential length of the chamfer by the circumferential length of the pole region is between 0.193 and 0.194.

8. The magnet of claim 6, wherein a cross section of the chamber is formed as a straight line or a curve.

9. A magnet comprising a plurality of pole regions formed in an arc shape and arranged in parallel in a circumferential direction,
wherein each of the plurality of pole regions has a magnetic focus center different from a center of an inner diameter of the plurality of pole regions,
chamfers formed on inner surfaces of both ends of the pole region, and
a value obtained by dividing a radial length of the chamfer by a radial length of the pole region is between 0.16 and 0.17.

10. The magnet of claim 9, wherein the value obtained by dividing the radial length of the chamfer by the radial length of the pole region is between 0.166 and 0.167.

11. The magnet of claim 9, wherein a value obtained by dividing a circumferential length of the chamfer by a circumferential length of the pole region is between 0.155 and 0.165.

12. The magnet of claim 11, wherein the value obtained by dividing the circumferential length of the chamfer by the circumferential length of the pole region is between 0.1595 and 0.1605.

13. The magnet of claim 9, wherein a cross section of the chamber is formed as a straight line or a curve.

14. The magnet of claim 9, wherein the plurality of pole regions satisfy the following Expression,
$$X = \frac{{d}_{m}}{{d}_{b}}$$
(here, dₘ is a distance from a straight line connecting both ends of a magnetic center line of the plurality of pole regions to a central region of the magnetic center line of the plurality of pole regions, and do is a distance from a straight line connecting both ends of the magnetic center line of the plurality of pole regions to the central region of the magnetic center line of the plurality of pole regions when the plurality of pole regions have the same magnetic focus center as the center of the inner diameter of the plurality of pole regions),
X<6 when the plurality of pole regions is 2,
X<4.5 when the plurality of pole regions is 3, and
X<3.5 when the plurality of pole regions is 4.

15. A magnet comprising a plurality of pole regions formed in an arc shape and arranged in parallel in a circumferential direction,
wherein each of the plurality of pole regions has a magnetic focus center different from a center of an inner diameter of the plurality of pole regions,
chamfers formed on inner surfaces of both ends of the pole region, and
a value obtained by dividing a circumferential length of the chamfer by a circumferential length of the pole region is between 0.155 and 0.165.

16. The magnet of claim 15, wherein the value obtained by dividing the circumferential length of the chamfer by the circumferential length of the pole region is between 0.1595 and 0.1605.

17. The magnet of claim 15, wherein a cross section of the chamber is formed as a straight line or a curve.

18. The magnet of claim 15, wherein the plurality of pole regions satisfy the following Expression,
$$X = \frac{{d}_{m}}{{d}_{b}}$$
(here, dₘ is a distance from a straight line connecting both ends of a magnetic center line of the plurality of pole regions to a central region of the magnetic center line of the plurality of pole regions, and do is a distance from a straight line connecting both ends of the magnetic center line of the plurality of pole regions to the central region of the magnetic center line of the plurality of pole regions when the plurality of pole regions have the same magnetic focus center as the center of the inner diameter of the plurality of pole regions),
X<6 when the plurality of pole regions is 2,
X<4.5 when the plurality of pole regions is 3, and
X<3.5 when the plurality of pole regions is 4.

19. A motor comprising:
a stator; and
a rotor including a rotor core arranged radially outside the stator and a plurality of magnets arranged on an inner surface of the rotor core and facing the stator,
wherein the magnet is the magnet according to claim 1.

20. A washing machine comprising the motor according to claim 19.
